(19) United States
(12) Patent Application Publication
(10) Pub. No.: US 2013/0203373 A1
(43) Pub. Date: Aug. 8, 2013

(54) EMERGENCY MESSAGING BETWEEN CITIZENS AND AUTHORITIES

(71) Applicant: Stephen William EDGE, Escondido, CA (US)

(72) Inventor: Stephen William EDGE, Escondido, CA (US)

(73) Assignee: QUALCOMM Incorporated, San Diego, CA (US)

(21) Appl. No.: 13/571,923

(22) Filed: Aug. 10, 2012

Related U.S. Application Data
(60) Provisional application No. 61/523,232, filed on Aug. 12, 2011.

(51) Int. Cl. H04W 4/22

(52) U.S. Cl. CPC H04W 4/22
USPC 455/404.2; 455/404.1

(57) ABSTRACT

Methods, apparatus, systems, and computer-readable media to support emergency messaging are described herein. Examples of the embodiments enable messaging, such as SMS text messaging, sent from a mobile station to be routed to a public safety answering point (PSAP) that services the area where the mobile station is currently located. In one example embodiment, the Mobile services Switching Center (MSC) filters message for emergency numbers (e.g., 911 or 112) and reroutes the message to an emergency service provider using an emergency services routing number such as an ESRK or ESRD provided by a gateway server such as a GMLC or MPC.

### CROSS-REFERENCE TO RELATED APPLICATIONS

This patent application claims the benefit of U.S. Provisional Patent Application Ser. No. 61/523,232 filed Aug. 12, 2011, and entitled “EMERGENCY SMS MESSAGING,” which is incorporated by reference herein in its entirety for all purposes.

### BACKGROUND OF THE INVENTION

The present disclosure relates generally to communication, and more specifically to techniques for supporting emergency messaging between citizens and public safety authorities.

In recent years, mobile phone ownership has grown rapidly throughout the world. Due to this enormous growth, mobile phones have quickly become the primary mode of communication for many people. During emergency situations, people often use their mobile phones to call emergency numbers, such as 911 or 112. While current systems support voice calls to be placed to emergency services, it is currently not normally feasible to send messages, such as short message service (SMS) text messages, Instant messages (IM) or multimedia messages, to an emergency services authority such as a Public Safety Answering Point (PSAP).

### BRIEF SUMMARY OF THE INVENTION

Methods, apparatus, systems, and computer-readable media to support emergency messaging are described herein. Examples of the embodiments enable messaging, such as SMS messaging, sent from a mobile station to be routed to a PSAP that services the area where the mobile station is currently located. In one example embodiment, the Mobile Services Switching Center (MSC) filters messages for emergency numbers (e.g., 911 or 112) and reroutes the message to an emergency service provider according to embodiments of the invention.

An example of a method for emergency messaging includes receiving a message from a mobile station, determining that the message contains an emergency service number, determining an emergency service routing number usable to identify a public safety answering point, substituting the emergency service number with the emergency service routing number in the message, and forwarding the message for delivery to the public safety answering point, wherein the delivery of the message is based on the emergency service routing number. The emergency service routing number may be an emergency service routing key (ESRK) or emergency service routing digits (ESRD). In one implementation, determining the emergency service routing number includes determining location information for the mobile station. The location information may be a serving cell identifier or a geographic location. The messages may be forwarded through a Short Message Service Center (SMSC) or a Message Center (MC). In example implementations, the message may be received using a GSM, a CDMA, a WCDMA, a CMDA2000 1x, or a LTE network.

In one example implementation of the method, the message may include a text message and the text message may be an SMS message. In yet other implementations of the method, the message may include non-real time messages. In one example implementation, the method further includes receiving a response from the public safety answering point. The response may be a circuit switched voice call or an SMS response message.

In one example embodiment, determining the emergency service routing number includes sending a query to a gateway server and receiving, from the gateway server, the emergency service routing number. The gateway server may be a Gateway Mobile Location Center (GMLC) or a Mobile Position Center (MPC). In one implementation, the emergency service routing number identifies the gateway server. Furthermore, the method may include receiving a location query for the mobile station from the public safety answering point, wherein the location query may be transmitted to the gateway server and wherein the gateway server obtains a location associated with the mobile station and returns the location to the public safety answering point.

In some example embodiments of the method, the method may further include receiving another message from the mobile station within a predefined time period, and forwarding another message for delivery to the public safety answering point, wherein the delivery of the another message may be based on the emergency service routing number. The messages may be routed through a Short Message Service Center (SMSC) or a Message Center (MC). In some other example embodiments of the method, the method may also include receiving a request to establish an emergency voice call from the mobile station, and forwarding the request to the public safety answering point, wherein routing of the request is based on the emergency service routing number.

An example device for emergency messaging may include a transceiver configured to receive a message from a mobile station, and a processor configured to determine that the message contains an emergency service number, determine an emergency service routing number usable to identify a public safety answering point, and substitute the emergency service number with the emergency service routing number in the message. The transceiver may be further configured to forward the message for delivery to the public safety answering point, wherein the delivery of the message is based on the emergency service routing number. The emergency service routing number may be an emergency service routing key (ESRK) or emergency service routing digits (ESRD). In one implementation, determining the emergency service routing number includes determining location information for the mobile station. The location information may be a serving cell identifier or a geographic location. The messages may be forwarded through a Short Message Service Center (SMSC) or a Message Center (MC). In example implementations, the message may be received using a GSM, a CDMA, a WCDMA, a CMDA2000 1x, or a LTE network.

In one example implementation of the device, the message may include a text message and the text message may be an SMS message. In yet other implementations of the device, the message may include non-real time messages. In one example implementation, the device may be further configured to receive a response from the public safety answering point, via the transceiver. The response may be a circuit switched voice call or an SMS response message.

In one example embodiment of the device, determining the emergency service routing number includes sending a query to a gateway server, via the transceiver, and receiving, from the gateway server, via the transceiver, the emergency service routing number. The gateway server may be a Gateway Mobile Location Center (GMLC) or a Mobile Position Center (MPC). In one implementation, the emergency service routing number identifies the gateway server. Furthermore, the device may be configured to receive a location query for the mobile station from the public safety answering point, via the transceiver, wherein the location query may be transmitted to the gateway server, via the transceiver, and wherein the gateway server obtains a location associated with the mobile station and returns the location to the public safety answering point.

In some example embodiments of the device, the device may be further configured to receive another message from the mobile station within a predefined time period, via the transceiver, and forward another message for delivery to the public safety answering point, via the transceiver, wherein the delivery of the another message may be based on the emergency service routing number. The messages may be routed through a Short Message Service Center (SMSC) or a Message Center (MC). In some other example embodiments of the device, the device may be configured to receive a request to establish an emergency voice call from the mobile station, and forward the request to the public safety answering point, wherein routing of the request is based on the emergency service routing number.

An example apparatus for a non-transitory computer readable storage medium coupled to a processor, wherein the non-transitory computer readable storage medium comprises instructions executable by the processor, includes receiving a message from a mobile station, determining that the message contains an emergency service number, determining an emergency service routing number usable to identify a public safety answering point, substituting the emergency service number with the emergency service routing number in the message, and forwarding the message for delivery to the public safety answering point, wherein the delivery of the message may be based on the emergency service routing number.

An example apparatus for emergency messaging may include a means for receiving a message from a mobile station, means for determining that the message contains an emergency service number, means for determining an emergency service routing number usable to identify a public safety answering point, means for substituting the emergency service number with the emergency service routing number in the message; and means for forwarding the message for delivery to the public safety answering point, wherein the delivery of the message is based on the emergency service routing number.

The foregoing has outlined rather broadly the features and technical advantages of examples according to disclosure in order that the detailed description that follows can be better understood. Additional features and advantages will be described hereinafter. The conception and specific examples disclosed can be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages, will be better understood from the following description when considered in connection with the accompanying figures. Each of the figures is provided for the purpose of illustration and description only and not as a definition of the limits of the claims.

### BRIEF DESCRIPTION OF THE DRAWINGS

FIG. 1 is a diagram illustrating the communications exchanged between various entities in order to provide circuit switched voice emergency calls.

FIG. 2 illustrates an embodiment of a system for supporting emergency messaging.

FIG. 3 is a simplified flow diagram, illustrating a process 300 for routing of an SMS message to an emergency service according to one embodiment.

FIG. 4 is an exemplary signaling flow diagram illustrating the communications exchanged between various entities in order to route an SMS message to an emergency service.

FIG. 5 is a simplified flow diagram, illustrating a process 500 for the routing of a response according to one embodiment.

FIG. 6 is a signaling flow diagram illustrating the communications exchanged between various entities in order to route a response according to one embodiment.

FIG. 7 is a flow diagram illustrating the routing of emergency CS Calls and callbacks according to one embodiment.

FIG. 8 is a signaling flow diagram illustrating the communications exchanged between various entities in order to provide emergency CS Calls and callbacks according to one embodiment.

FIG. 9 is a flow diagram illustrating a location procedure used to support emergency SMS messaging according to one embodiment.

FIG. 10 is a signaling flow diagram illustrating the communications exchanged between various entities in order to perform a location procedure used to support emergency SMS messaging according to one embodiment.

FIG. 11 illustrates another embodiment of a system for supporting emergency messaging.

FIG. 12 is a flow diagram illustrating the routing of an SMS message to an emergency service according to one embodiment.

FIG. 13 is a signaling flow diagram illustrating the communications exchanged between various entities in order to route an SMS message to an emergency service according to one embodiment.

FIG. 14 is a flow diagram illustrating the routing of a response to an emergency SMS message according to one embodiment.

FIG. 15 is a signaling flow diagram illustrating the communications exchanged between various entities in order to route a response to an emergency SMS message according to one embodiment.

FIG. 16 is a flow diagram illustrating the routing of emergency CS Calls and callbacks according to one embodiment.

FIG. 17 is a signaling flow diagram illustrating the communications exchanged between various entities in order route emergency CS Calls and callbacks according to one embodiment.

FIG. 18 is a flow diagram illustrating a location procedure used to support emergency SMS messaging according to one embodiment.

FIG. 19 is a signaling flow diagram illustrating the communications exchanged between various entities in order to perform a location procedure used to support emergency SMS messaging according to one embodiment.

FIG. 20 is a simplified flow diagram, illustrating the method for communicating messages with an emergency services provider.

FIG. 21 is a diagram illustrating an exemplary computer system.

### ABBREVIATIONS

Various terms used herein may be referred to by a corresponding abbreviation. The following is a listing of abbreviations that may be used.

CS EMC (Circuit Switched Emergency Call)

EMI-UCP (External Machine Interface-Universal Computer Protocol)

ESME (Emergency Services Message Entity)

ESNE (Emergency Services Network Entity)

ESRD (Emergency Services Routing Digits)

ESRK (Emergency Services Routing Key)

GMLC (Gateway Mobile Location Center)

GMSC (Gateway MSC)

HLR (Home Location Register)

IAM (Initial Address Message)

IMSI (International Mobile Subscriber Identity)

ISUP (ISDN User Part (SS7 protocol))

LMSI (Local Mobile Subscriber Identity)

MAP (Mobile Application Part)

MC (Message Center for CDMA2000 networks)

MDN (Mobile Directory Number for CDMA2000 networks)

MIN (Mobile Identification Number)

MPC (Mobile Position Center)

MS (Mobile Station)

MSC (Mobile services Switching Center)

MSID (MS Identity for CDMA2000 networks (MIN or IMSI))

MSISDN (Mobile Subscriber ISDN number)

MSRN (Mobile Subscriber Roaming Number)

NANP (North American Numbering Plan)

PDE (Position Determining Entity)

PDU (Protocol Data Unit)

PSAP (Public Safety Answering Point)

PSTN (Public Switched Telephone Network)

RAN (Radio Access Network)

SAS (Standalone SMLC)

SME (Short Message Entity)

SMS (Short Message Service)

SMLC (Serving Mobile Location Center)

SMPP (Short Message Peer to Peer)

SMSC (Short Message Service Center)

S/R (Selective Router)

VMSC (Visited MSC)

### DETAILED DESCRIPTION

Techniques to support emergency messaging are described herein. Examples of the embodiments enable messaging, such as SMS text messaging, sent from a mobile station to be routed to a public safety answering point (PSAP) that services the area where the mobile station is currently located.

At present, mobile stations are generally able to connect to emergency services via circuit switched voice emergency calls (CS EMCs). Currently, there are no effective solutions for routing messages, such as SMS messages, 1M or multimedia messages, to an emergency service provider. In those systems that provide support for CS EMCs, a visited mobile services switching center (VMSC) serving a mobile station is typically configured to obtain either an emergency services routing key (ESRK) or emergency services routing digits (ESRD) from a gateway mobile location center (GMLC). The ESRK or ESRD received from the GMLC is thereafter used to (i) route a CS EMC from the VMSC to a PSAP (in which case the ESRK or ESRD is also typically passed to the PSAP as part of the emergency call origination) and (ii) route a subsequent location query from the PSAP to the GMLC. In the case of an ESRK, the ESRK can be used to additionally identify the mobile station to the GMLC for a location query.

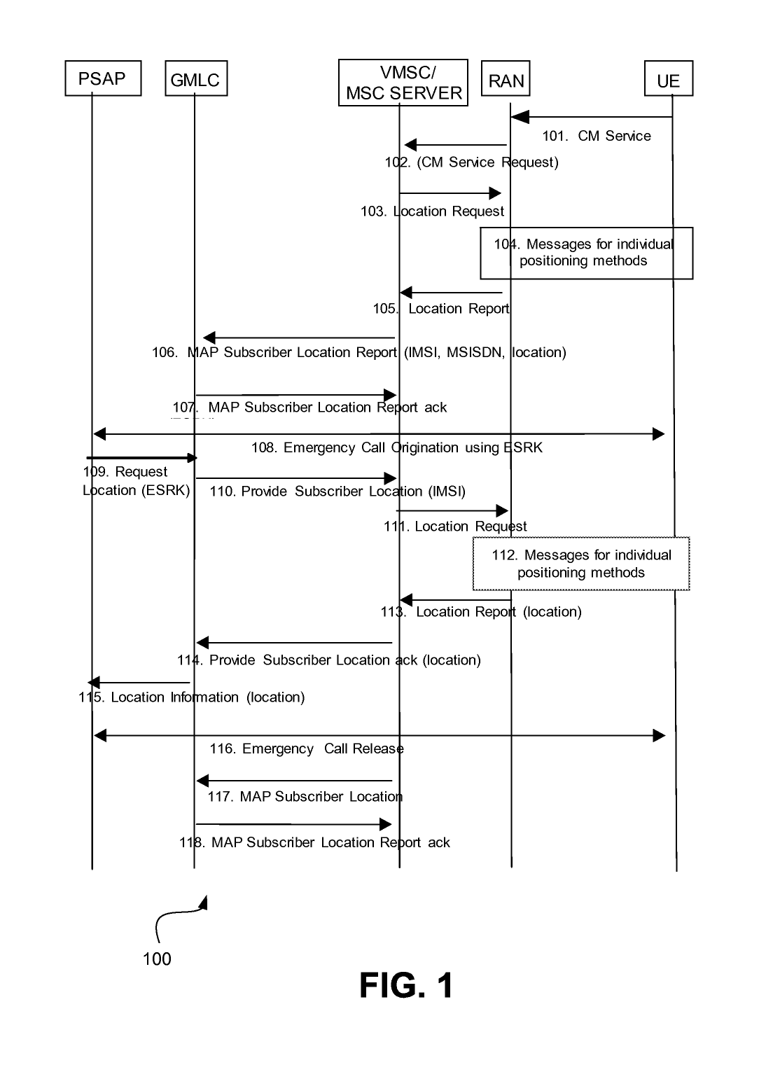

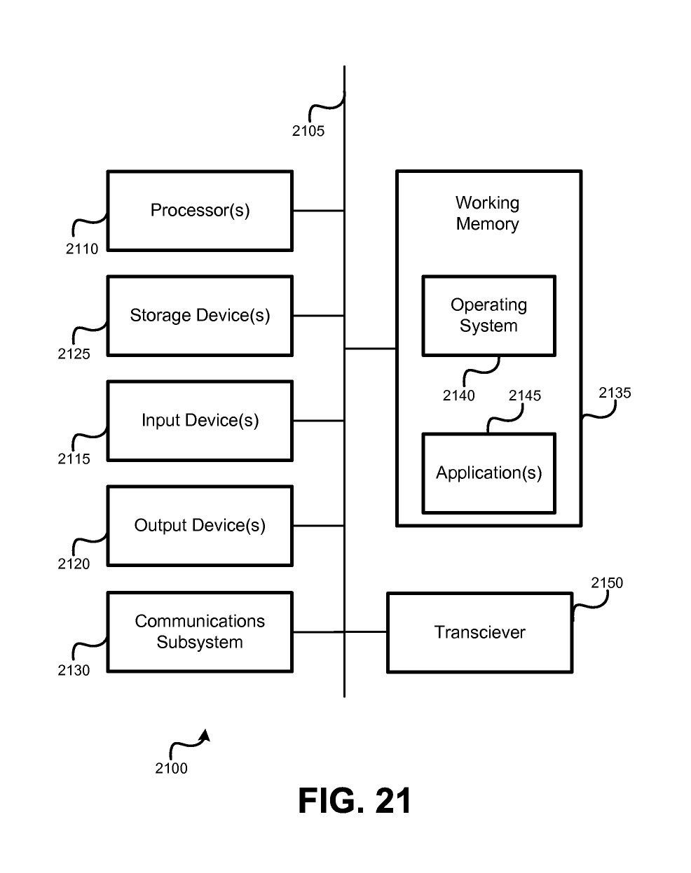

FIG. 1 is a diagram illustrating the communications exchanged between various entities in order to provide circuit switched voice emergency calls. FIG. 1 may be applicable to a CS EMC made using a Global System for Mobile Communications (GSM) or Wideband Code Division Multiple Access (WCDMA) network as defined by the 3^{rd} Generation Partnership Project (3GPP). In some embodiments, the principles and functions described with respect to FIG. 1 are applicable to other networks. The process 100 is performed by processing logic that comprises hardware (circuitry, dedicated logic, etc.), software (such as is run on a general purpose computing system or a dedicated machine), firmware (embedded software), or any combination thereof. In one embodiment, the process 100 is performed by one or more computer systems 2100 as described in FIG. 21.

Referring to FIG. 1, exemplary steps for establishing a CS EMC using an ESRK or ESRD based on existing 3GPP and American National Standards Institute (ANSI) solutions are shown. FIG. 1 may apply to a Mobile Station (MS), also known as a User Equipment (UE), that is initially in idle state without a radio connection to the network. At step 101, the mobile station may send a Connection Management (CM) Service Request message to the Radio Access Network (RAN) containing an indication that an emergency call is needed or desired or otherwise solicited. At step 102, the RAN forwards the message to the VMSC/MSC server. At step 103, the VMSC/MSC server sends a location request to the RAN. At step 104, messages for individual position methods may be generated between the RAN and UE or internally within the RAN. Examples of such positioning methods include standalone Global Positioning System (GPS), Assisted GPS (A-GPS), standalone Global Navigation Satellite System (GNSS), Assisted GNSS (A-GNSS), Observed Time Difference Of Arrival (OTDOA), Advanced Forward Link Trilateration (AFLT) and Enhanced Cell ID (E-CID) each of whose support may be standardized by 3GPP or the Third Generation Partnership Project 2 (3GPP2), or by another entity or may be associated with communications that are not standardized. Other positioning methods may also be used or implemented. At step 105, once a location for the UE is determined, the RAN sends the location report (e.g., location) to the VMSC/MSC server. At step 106, once the VMSC/MSC has the location, it communicates with the GMLC with the MAP Subscriber Location Report (containing the IMSI, MSISDN and location for the MS). At step 107, the GMLC returns a MAP Subscriber Location Report acknowledgment with the emergency service routing number, such as an ESRK or ESRD. The GMLC also stores the identity of the UE (e.g. IMSI, MSISDN), the address of the VMSC/MSC server and the ESRK or ESRD in a call record for the emergency call as part of step 107. At step 108, the emergency call is originated to a PSAP using the ESRK or ESRD to assist routing. Between steps 101 and 108 and not shown in FIG. 1, additional signaling may be exchanged between the UE and VMSC/MSC server to further support the emergency call. For example, the VMSC/MSC server may return a CM Service Accept message to the UE and the UE may subsequently send an Emergency SETUP message to the VMSC/MSC server.

As shown at step 109, the PSAP may request the location of the UE from the GMLC, for example using the ESRK or ESRD plus MSISDN. At step 110, the GMLC may use the ESRK or ESRD plus MSISDN to locate the call record stored in step 107 and sends a location request (e.g. a MAP Provide Subscriber Location) to the VMSC/MSC server indicated in the call record. At step 111, the VMSC/MSC server requests the location of the UE from the RAN. At step 112, the RAN may communicate with the UE and determines the location using individual positioning methods supported by the UE or may obtain the UE location using RAN specific positioning methods. Examples of such positioning methods include GPS, GNSS, A-GPS, A-GNSS, OTDOA, AFLT and E-CID. Other positioning methods may be used in addition to or in place of these methods. At step 113, 114 and 115, the location information is forwarded from the RAN to the VMSC/MSC server, to the GMLC and back to the PSAP. At step 116, the Emergency call is released. At step 117, the VMSC/MSC server sends the MAP Subscriber Location Report message to the GMLC with an indication of call release and the GMLC acknowledges the receipt of the MAP subscriber location report at step 118. The ESRK or ESRD is assigned by the GMLC after step 106 and released by the GMLC after step 117 along with other information stored in step 107.

In general, an ESRK rather than ESRD is used for emergency calls to PSAPs served by Multi Frequency (MF) trunks to support CS EMCs that allow only one number to be delivered to the PSAP. For other types of PSAPs, an ESRD may be used instead of an ESRK. Typically, an ESRK is a telephone number (e.g. 10 digit NANP number) that (i) identifies the destination P SAP, (ii) identifies the GMLC and (iii) temporarily identifies the calling mobile station. An ESRK is assigned to an originating CS EMC from a common pool. After the CS EMC is released, the ESRK is returned to the common pool. An ESRD is similar to an ESRK (e.g. 10 digit NANP number) but only identifies the destination PSAP and GMLC (not the calling mobile station). As such, an ESRD can be used for multiple mobile stations (i.e. is not assigned at any one time to just one mobile station).

As discussed above, current mobile communications systems do not effectively support the routing of messages, such as SMS messages or multimedia messages, to and from an emergency service. Embodiments of the present invention, as described herein, enable such support.

Although embodiments of the invention are described below using an SMS message for illustrative purposes, other types of messages may be transmitted such as 1M or multimedia messages. In some embodiments, other non-real time messages, such as messages which are delay tolerant messages, may be utilized. In some embodiments, text messages which do not conform to SMS may be utilized, as may messages containing pictures or pre-recorded audio and/or video or types of MMS messages, for example. Similarly, although GSM and WCDMA networks are discussed below in detail, any other suitable network that supports voice calls to an emergency service number, such as a Long Term Evolution (LTE) network defined by 3GPP, a Code Division Multiple Access 2000-1 times Radio Transmission Technology (CDMA2000 1xRTT) network and a High Rate Packet Data (HRPD) network defined by 3GPP2, a Worldwide Interoperability for Microwave Access (WiMax) network defined by the Institute of Electrical and Electronics Engineers (IEEE), or a WiFi network defined by IEEE, may implement embodiments of the invention. Those of skill in the art will appreciate that other networks may in addition or instead be used to implement embodiments of the invention.

In one embodiment applicable to GSM and WCDMA or other variant networks, a mobile station (e.g., a mobile phone) can transmit a message, such as an SMS message, to an emergency service number, such as 911 or 112. From the perspective of the mobile station, the message may appear to be a normal message whose destination address happens to contain digits like 911 in North America or 112 or 999 in Europe that commonly signify an emergency situation. However, the mobile station may be unaware of this significance (e.g. because it has not been programmed to translate the address) and thus may support transfer of the message to the network without any additional impacts. This may be an advantage to users in allowing any mobile station to originate such a message rather than requiring use of some upgraded mobile station with additional specialized capability. The message can be received by a server, comprising a processor and a transceiver, such as a visited mobile services switching center (VMSC). Upon receipt of the message, the VMSC can determine that the SMS message is addressed to an emergency service number. Thereafter, the VMSC can determine the location of the mobile station, and request an emergency service routing number from a gateway server, such as a gateway mobile location center (GMLC). In some embodiments, the emergency service routing number requested from the GMLC can be at least one of an emergency services routing key (ESRK) or an emergency services routing digits (ERSD). Upon receiving the emergency service routing number, the VMSC can replace the emergency service number with the emergency service routing number. Thereafter, the VMSC can transmit the SMS message to the mobile station's home network short message service center (SMSC) or to a visited network's SMSC. Thereafter, the SMSC routes the SMS message to the PSAP associated with the emergency service routing number. Subsequent SMS messages addressed to the emergency service can thereafter be routed to the same PSAP using the same emergency service routing number. Furthermore, if a voice call is initiated via the mobile station, the VMSC can use the same emergency service routing number to route the call to the same PSAP.

In another embodiment applicable to GSM and WCDMA networks, the VMSC may determine the ESRK or ESRD itself based on the serving cell or the geographic location of the mobile station. In this embodiment, the VMSC may send the ESRK or ESRD to a gateway server such as a GMLC.

In still another embodiment applicable to CDMA networks, a mobile station (e.g., a mobile phone) can transmit an SMS message to an emergency service number, such as 911 or 112. The message can be received by a visited mobile services switching center (VMSC). Upon receipt of the message, the VMSC can determine that the SMS message is addressed to an emergency service number. Thereafter, the VMSC can request an emergency service routing number from a gateway server, such as a mobile positioning center (MPC). In some embodiments, the emergency service routing number requested from the MPC can be at least one of an emergency services routing key (ESRK) or an emergency services routing digits (ERSD). Upon receiving the emergency service routing number, the VMSC can forward the SMS message in a MAP SMSDeliveryPointToPoint (SMDPP) message to a Message Center (MC) in the mobile station's home network. The SMDPP message can include the emergency service routing number as its destination address. Thereafter, the Message Center routes the SMS message to the PSAP associated with the emergency service routing number. Subsequent SMS messages addressed to the emergency service can thereafter be routed to the same PSAP using the same emergency service routing number. Furthermore, if a voice call is initiated via the mobile station, the VMSC can use the same emergency service routing number to route the call to the same PSAP.

In a further embodiment applicable to CDMA networks, the VMSC may determine the ESRK or ESRD itself based on the serving cell or the geographic location of the mobile station. In this embodiment, the VMSC may send the ESRK or ESRD to a gateway server such as an MPC.

Embodiments, through routing an SMS message in the manner described above, enable an emergency SMS message to use the same emergency service numbers that are valid for circuit switched voice emergency (CS EMC) calls (e.g., 911, 112, etc.). Furthermore, embodiments enable different emergency messages sent from a mobile station within a certain timeframe (e.g., separated by up to 15 minutes) to be routed to the same PSAP operator. In addition, a CS EMC that is instigated by a mobile station just before or just after an emergency SMS message can be routed to the same PSAP operator as the SMS message. Embodiments furthermore enable emergency SMS support without impacting a mobile station—thereby enabling support for existing mobile stations. Embodiments additionally allow support for both a user subscription-based emergency SMS service and an emergency SMS service that is not subscription-based. Embodiments further enable emergency SMS support for subscribers that are either home subscribers or subscribers roaming in from other networks including networks in other countries.

In certain situations, it may be advantageous for sending messages to an emergency service provider using a non-real time message using embodiments of the invention. For instance, the real time routing of a CS EMC may not be possible due to network congestion. In addition, emergency situations may manifest where sending a non-real time message may be most suitable. For instance, the user in an emergency situation may want to send a picture file or a video clip to an emergency service provider. In another situation, making a voice call may further jeopardize the safety of the user and sending a text message may be the safest option for the user. For example, in an exemplary situation, where a burglar may have entered the household, the user may not want to further attract the burglar's attention by placing a voice call. Instead the user can send a request for services using an SMS message.

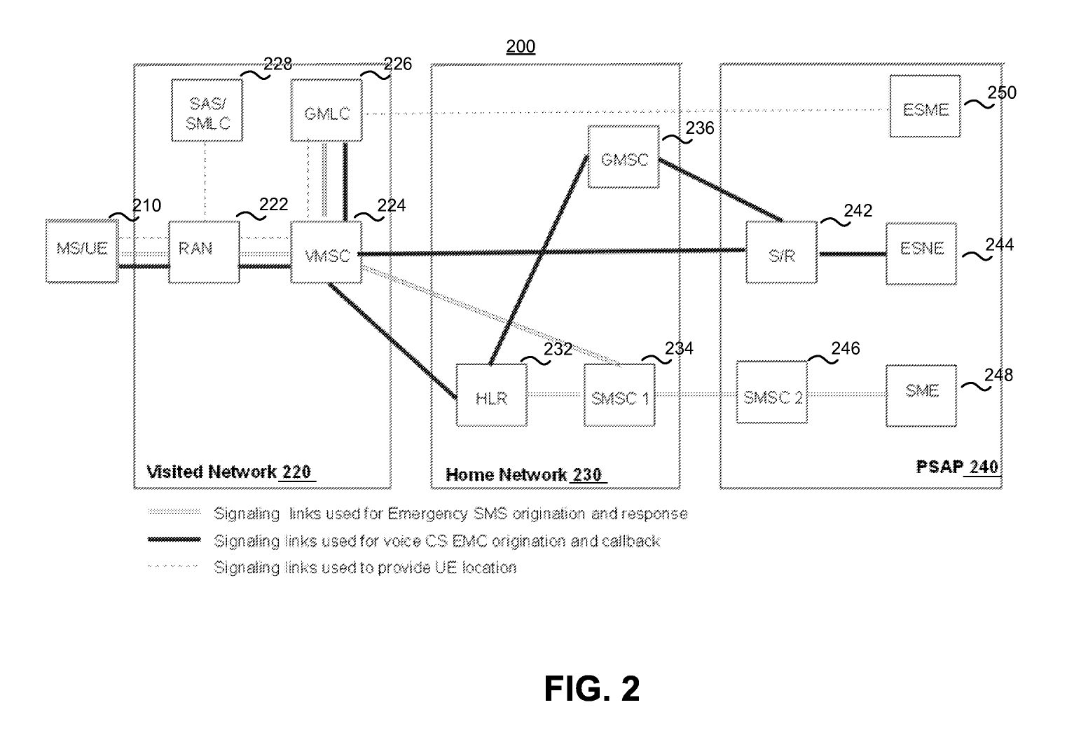

FIG. 2 illustrates a system 200 for supporting emergency SMS messaging according to one embodiment. In some embodiments, other non-real time messages, such as messages which are delay tolerant messages, may be utilized. In some embodiments, text messages which do not conform to SMS may also be utilized, as may picture or audio and/or video messages or other types of multimedia messages, for example. System 200 can be used within a 3GPP network such as a GSM or WCDMA network, or other communication networks. As shown in FIG. 2, system 200 can include mobile station (MS) 210, which can also be referred to as a user equipment (UE) terminal or target device. An exemplary computer system 2100, as illustrated in FIG. 21, or components of such a computer system may perform embodiments of the invention and represent the mobile station 210 or components of the mobile station 210. Mobile station 210 can be any suitable stationary or mobile device, such as a mobile phone, a computer, a laptop, a personal digital assistant (PDA), a tablet device, a portable media device, and/or the like. In addition, other entities discussed in FIG. 2, such as RAN 222, VMSC 234, SAS/SMLC 228, GMLC 226, HLR 232, GMSC 236, SMSC 234, SMSC 246, S/R 242, ESNE 244, ESME 250, SME 248 may be implemented using the computer system 2100 or components of the computer system 2100 as described in FIG. 21.

As shown in FIG. 2, system 200 can include a visited network 220, a home network 230, and a PSAP 240. Visited Network 220 may provide mobile services to MS/UE 210 (e.g. originate and terminate calls on behalf of MS/UE 210) and can include radio access network (RAN) 222 which may support radio access to MS/UE 210, visited mobile services switching center (VMSC) 224 which may support calls to and from MS/UE 210, gateway mobile location center (GMLC) 226 which may support location requests for MS/UE 210, and serving mobile location center (SMLC) 228 which may support location of MS/UE 210. In some embodiments, VMSC 224 can, among performing other functions, scan or filter SMS messages received from mobile station 210 via RAN 222. The VMSC 224, may have a transceiver for receiving and transmitting message, in addition to other components. If an emergency service number (e.g., 911 or 112) is detected in an SMS message, VMSC 224 can obtain an emergency service routing number (e.g., ESRK or ESRD). The emergency service routing number can be used to route the SMS message to a PSAP (e.g., PSAP 240) that serves the area where mobile station 210 is located. In some embodiments, VMSC 224 can communicate with SMLC 228 and GMLC 226 in order to obtain the emergency service routing number. VMSC 224 may additionally be configured to directly or indirectly communicate with home network 230 and/or PSAP 240.

Referring again to FIG. 2, home network 230 may be the home network for MS/UE 210 and may be the same network as Visited network 220 or a different network. Home network 230 can include home location register (HLR) 232 which may store subscription data for MS/UE 210, short message service center (SMSC) 234 which may support SMS message transfer to and from MS/UE 210, and gateway mobile services switching center (GMSC) 236 which may support incoming calls to MS/UE 210. In some embodiments, one or more of HLR 232, SMSC 234, and GMSC 236 may be configured to support the routing of emergency SMS messages and CS EMC calls. As shown in FIG. 2, PSAP 240 can include selective router (S/R) 242 which may be used to route a CS EMC from a network such as visited network 220 to a particular PSAP such as PSAP 240, an emergency services network entity (ESNE) 244 which may be the destination of an incoming CS EMC, SMSC 246 which may support SMS transfer, short message entity (SME) 248 which may be an endpoint that can originate and receive SMS messages for PSAP 240, and emergency services message entity (ESME) 250 which may request and receive location information for MS/UE 210 in the context of a CS EMC or emergency SMS message originated from MS/UE 210. PSAP 240 may be configured to support the providing of emergency services to mobile station 210 via SMS messaging and/or CS EMCs.

As shown in FIG. 2, the various entities can communicate over a number of communication links. It should be appreciated that some of the communication links shown in FIG. 2 may be indirect (i.e. may include intermediate entities that are not shown such as other networks). Furthermore, ESME 250, ESNE 244 and SME 248 of FIG. 2 can be either separate or combined functions, or some combination of separate and combined functions, in the same PSAP that provides service to one or more PSAP operators. The PSAP may be implemented as a single device or apparatus or across several. A computer system as illustrated in FIG. 21 may incorporate the various entities shown in FIGS. 2.

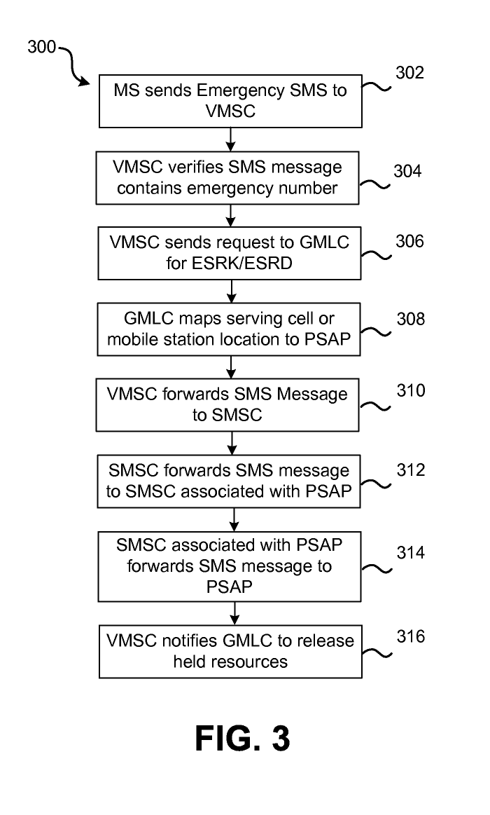

In FIG. 2, the solid line represents signaling links used for voice CS EMC origination and callback. The single dotted line represents signaling links used to provide UE location. And, the double line represents signaling links used for emergency SMS origination and response. It should also be appreciated that links between entities such as MS/UE 210 and RAN 222 may be separate or integrated links over various media for emergency messaging, voice CS EMC origination and callback, and for providing UE location. Examples of processes that can be used to provide emergency services based on SMS messaging will now be described. The processes shown in FIGS. 3-10 can be performed by the various entities shown in system 200 of FIG. 2.

FIG. 3 is a simplified flow diagram, illustrating a process 300 for routing of an SMS message to an emergency service according to one embodiment. An SMS message is used for illustration purposes; however, other non-real time messages may be used for communicating with the emergency service provider. The process 300 is performed by processing logic that comprises hardware (circuitry, dedicated logic, etc.), software (such as is run on a general purpose computing system or a dedicated machine), firmware (embedded software), or any combination thereof. In one embodiment, the process 300 is performed by one or more computer systems 2100 as described in FIG. 21.

Process 300 begins at step 302 with mobile station 210 sending an emergency SMS message to VMSC 224 via RAN 222. Mobile station 210 may also send the address of its home SMSC 234 to VMSC 224 along with the SMS message. At step 304, VMSC 224 verifies that the SMS message contains an emergency number (e.g. 911, 112). In some embodiments, VMSC 224 can additionally obtain the location of mobile station 210—e.g. by sending a location request to RAN 222 which may then invoke positioning of mobile station 210 (e.g. using A-GPS, A-GNSS, OTDOA, AFLT, E-CID, or other method) and return the obtained location to VMSC 224. In any case, VMSC 224 may know the serving cell of mobile station 210 which may indicate an approximate location for mobile station 210. At step 306, VMSC 224 sends a request to GMLC 226 for an emergency service routing number, such as an ESRK or ESRD. In some embodiments, VMSC 224 only requests an ESRK or ESRD if the VMSC does not yet have an ESRK or ESRD for mobile station 210. In some embodiments, the request sent to GMLC 226 can include mobile station's 210 IMSI, MSISDN, serving cell and location (if previously obtained at step 304). At step 308, GMLC 226 maps the serving cell or mobile station location to a PSAP (e.g., PSAP 240) that services that location or cell area. In addition, GMLC 226 assigns an ESRK or determines an ESRD that identifies the PSAP (as well as the GMLC) and returns the ESRK or ESRD to VMSC 224. In some embodiments, GMLC 226 additionally stores mobile station 210's IMSI, MSISDN, ESRK or ESRD, serving cell, location if provided and VMSC 224's address. GMLC 226 then returns the assigned ESRK or ESRD to VMSC 224.

At step 310, VMSC 224 replaces the destination emergency number (e.g. 911 or 112) in the SMS message with the number contained in the ESRK or ESRD returned in step 308. VMSC 224 then forwards the SMS message to SMSC 234 using mobile application part (MAP). At step 312, SMSC 234 forwards, in certain embodiments, the SMS message to SMSC 246, which is associated with destination PSAP 240. At step 314, SMSC 246 forwards the SMS message to PSAP 240 (e.g. to SME 248 in PSAP 240), which is identified by the ESRK or ESRD and may use an IP based protocol like SMPP or EMI-UCP for transport. In other embodiments, SMSC 234 can forward the SMS message directly to destination PSAP 240 identified by the ESRK or ESRD instead of performing steps 312 and 314. At step 316, following some interval during which no new emergency SMS messages are sent by mobile station 210 and where no CS EMC has been initiated, VMSC 224 notifies GMLC 226 that any held resources (e.g. the ESRK) can be released.

In some embodiments, steps 302, 310, 312, and 314 can be repeated to transfer further SMS messages from mobile station 210 to PSAP 240. In such embodiments, VMSC 224 uses the same ESRK or ESRD as in the first invocation of step 310. Furthermore, PSAP 240 can use the ESRK/ESRD and MSISDN in each received SMS message to pass each message to the same operator—e.g. by recording the ESRK/ESRD, MSISDN and PSAP operator identity when the first SMS message is transferred and using the ESRK/ESRD and MSISDN in subsequent messages to retrieve the PSAP operator identity. In other embodiments, as an alternative to steps 310 to 314, VMSC 224 can send each emergency SMS message directly to PSAP 240 (or to SMSC 246) and, as a result, bypass SMSC 234, thereby reducing delay and possibly avoiding impacts to home network SMSCs (e.g. SMSCs in other countries for users from other countries). In still other embodiments, VMSC 224 can send each emergency SMS message to an SMSC in visited network 220 for onward transfer to SMSC 246 or PSAP 240.

It should be noted that step 304, in which VMSC 224 verifies that the message received from mobile station 210 in step 302 contains an emergency number, may be performed for any mobile station or may only be performed for certain mobile stations. In the former case, the service may be available to all users. In the latter case, the service may be restricted to only certain users. As an example of this, step 304 may only be performed for mobile stations whose subscription in HLR 232, which may be downloaded to VMSC 224 when mobile station 210 registers with visited network 220, indicates that emergency messages are to be supported. In this embodiment, the operator of visited network 220 may charge the user for supporting emergency messages by sending the charge to the operator for home network 230.

It should be appreciated that the specific steps illustrated in FIG. 3 provide a particular process of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 3 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process 300.

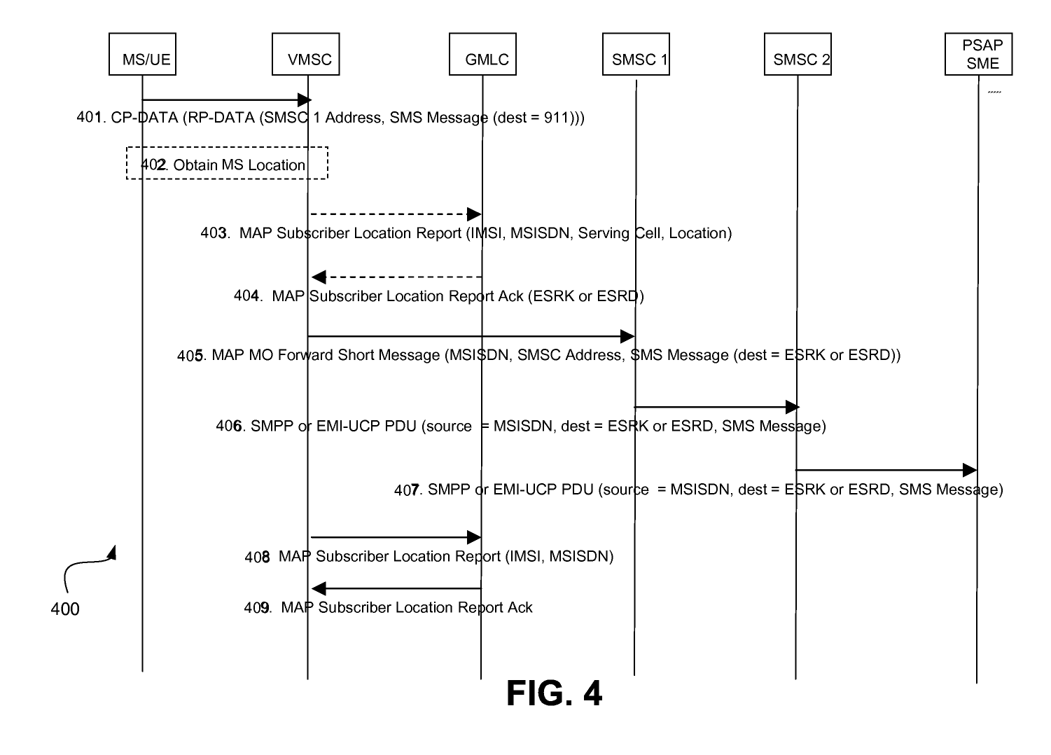

FIG. 4 is an exemplary signaling flow diagram illustrating the communications exchanged between various entities in order to route an SMS message to an emergency service. FIG. 4 is a signaling flow diagram for the flow described with respect to FIG. 3. An SMS message is used for illustration purposes; however, other non-real time messages may be used for communicating with the emergency service provider. The steps of FIG. 4 are performed by processing logic that comprises hardware (circuitry, dedicated logic, etc.), software (such as is run on a general purpose computing system or a dedicated machine), firmware (embedded software), or any combination thereof. In one embodiment, the steps are performed by one or more computer systems 2100 similar to FIG. 21.

At step 401, the mobile station 210 (or UE) sends an emergency SMS message to the VMSC 224 and includes the address of SMSC 1 which is the home SMSC 234 for mobile station 210. At step 402, the VMSC 224 verifies that the SMS message contains an emergency number (e.g. 911, 112) and may then obtain the UE location—e.g. by sending a location request to RAN 222 which may then invoke positioning of mobile station 210 (e.g. using A-GPS, A-GNSS, OTDOA, AFLT, E-CID, or other method) and return the obtained location to VMSC 224. At step 403, the VMSC 224 may send a request to a GMLC 226 for an ESRK or ESRD if it does not yet have an ESRK or ESRD for the mobile station 210. VMSC 224 may include in the request, the IMSI, MSISDN, serving cell and, if obtained, the location of mobile station 210. At step 404, the GMLC 226 maps the serving cell or mobile station 210 location to a PSAP 240 that services that location or cell area. The GMLC 226 also assigns an ESRK or determines an ESRD that identifies the PSAP 240 (as well as the GMLC 226) and returns the ESRK or ESRD to the VMSC 224. The GMLC 226 may store the UE's IMSI, MSISDN, ESRK or ESRD, serving cell, location and the VMSC address. In one embodiment, the stored information may be referenced for callbacks and responses from the PSAP 240. At step 405, the VMSC 224 may forward the SMS message along with the MSISDN of mobile station 210 to the mobile station 210's home SMSC 1 (block 234) using MAP and includes the ESRK or ESRD as the destination address in place of the emergency number (e.g. 911 or 112) received in step 401. At step 406, SMSC 1 (block 234) may determine routing for the destination PSAP 240 based on the ESRK or ESRD and forwards the SMS message, MSISDN and ESRK or ESRD to another SMSC 2 (block 246) associated with the destination PSAP 240 using an IP based transport protocol, such as SMPP or EMI-UCP. Alternatively, SMSC 1 (block 234) may forward the SMS message, MSISDN and ESRK or ESRD directly to the destination PSAP 240 identified by the ESRK or ESRD (not shown in FIG. 4). At step 407, SMSC 2 (block 246) may forward the SMS message, MSISDN and ESRK or ESRD to the PSAP (e.g. to SME 248 in PSAP 240) identified by the ESRK or ESRD using an IP based transport protocol, such as SMPP or EMI-UCP. At step 408 and 409, following some interval during which no new emergency SMS messages are sent by the mobile station 210 and provided there is no CS EMC, the VMSC 224 may notify the GMLC 226 that resources (e.g. the ESRK and items stored in step 404) may be released.

Steps 401, 405, 406 and 407 can be repeated for further SMS messages with the VMSC 224 using the same ESRK or ESRD as in step 405. The PSAP 240 can use the ESRK/ESRD and MSISDN in each received SMS message to pass each message to the same operator—e.g. by recording the ESRK/ESRD, MSISDN and operator identity when the first SMS message is transferred and using the ESRK/ESRD and MSISDN in subsequent messages to retrieve the operator identity. As an alternative to steps 405 to 407, the VMSC 224 could send each emergency SMS message directly to the PSAP 240 (or to SMSC 2 (block 246)) and bypass SMSC 1 (block 234) thereby reducing delay or the VMSC 224 could send each emergency SMS message to an SMSC (not shown) in the visited network for onward transfer to SMSC 2 (246) or the PSAP 240.

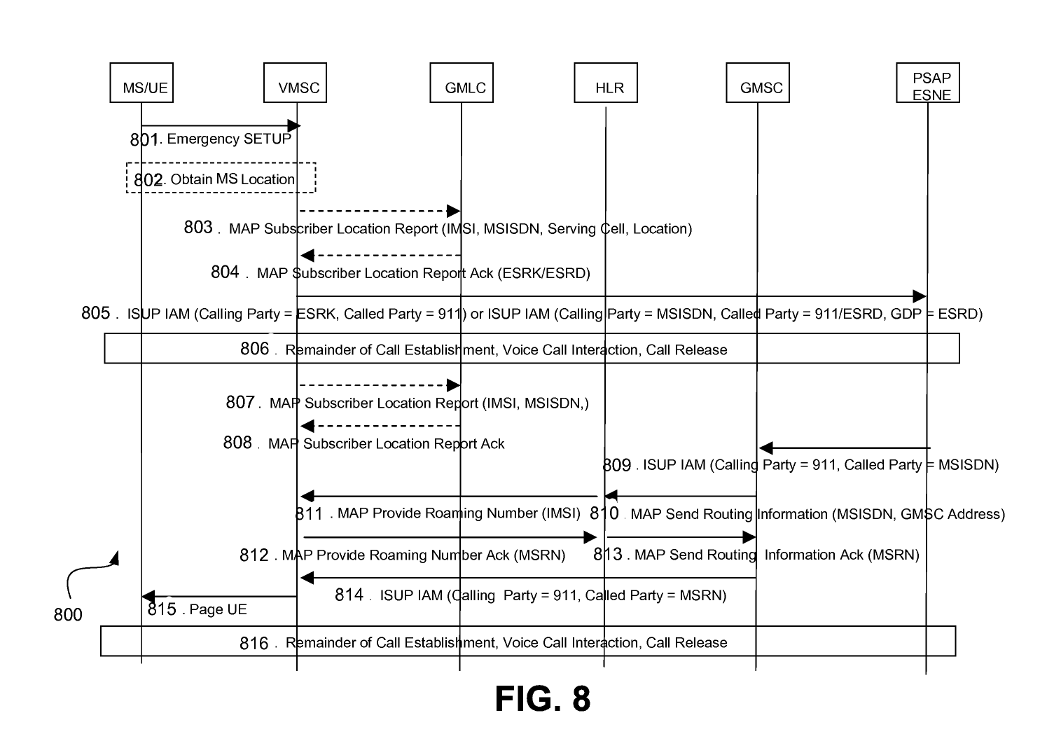

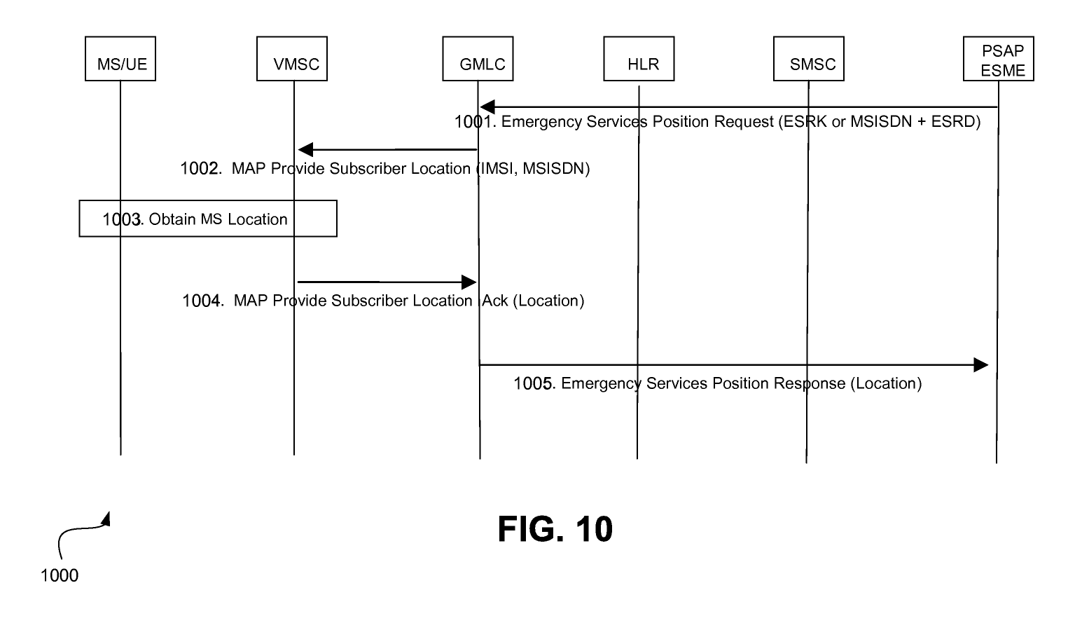

In some embodiments, determination that an SMS message sent from mobile station 210 contains an emergency address may not be made at VMSC 224 but may instead be made at the home SMSC 234 for mobile station 210. In that case, steps 402, 403 and 404 in FIG. 4 may not be performed and the SMS message forwarded in step 405 by VMSC 224 in FIG. 4 may contain the emergency number inserted by mobile station 210. When SMSC 234 determines that the SMS message received in step 405 contains an emergency number it may instigate steps similar to or the same as steps 403 and 404 to obtain an ESRK or ESRD from GMLC 226 and may then replace the emergency number in the SMS message with the received ESRK or ESRD. GMLC 226 may then record the ESRK or ESRD as well as the identity (e.g. MSISDN) of mobile station 210 in order to return the same ESRK or ESRD, for example (i) for any later query from SMSC 234 for a subsequent SMS message sent from mobile station 210 or (ii) for a query from VMSC 224 related to a CS EMC (e.g. as in steps 803 and 804 of FIG. 8 described later herein). SMSC 234 may further provide GMLC 226 with the address of VMSC 224 which it may have received in step 405 in order to allow GMLC 226 to query VMSC 224 then or later (e.g. using steps the same as or similar to steps 1002 to 1004 in FIG. 10) for the location of mobile station 210. In initially obtaining the ESRK or ESRD, GMLC 226 may use the service area of VMSC 224 to determine PSAP 240 (and from this determine the ESRK or ESRD) or may query for the location or serving cell of mobile station 210 from VMSC 224 (e.g. using steps similar to or the same as steps 1002, 1003 and 1004 in FIG. 10) and use the location or serving cell to determine PSAP 240. After SMSC 234 has obtained the ESRK or ESRD from GMLC 226 and substituted this for the emergency number in the SMS message, SMSC 234 may resume FIG. 4 as described above at step 406. Steps 408 and 409 in this embodiment may be instigated by SMSC 234 and not by VMSC 224 to release the ESRK and/or any stored items in GMLC 226 after some time period during which no more SMS messages are sent by mobile station 210. If further SMS emergency messages are sent by mobile station 210, SMSC 234 may (i) use the same ESRK or ESRD for routing as for the first message if SMSC 234 has stored the ESRK or ESRD in association with mobile station 210's identity (e.g. MSISDN) or SMSC 234 may (ii) again query GMLC 226 for an ESRK or ESRD with GMLC 226 returning the same ESRK or ESRD as for the first SMS emergency message which GMLC 226 may retrieve from the association of the ESRK or ESRD with the mobile station 210 identification (e.g. MSISDN). In this embodiment, impacts to VMSC 224 may be reduced or eliminated but impacts may be increased in SMSC 234 and GMLC 226. Further, the embodiment may be restricted to cases where the visited and home networks 220 and 230 are the same.

It should be appreciated that the specific steps illustrated in FIG. 4 provide a particular process of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 4 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process 400.

FIGS. 3 and 4 describe exemplary processes for routing emergency messages from a mobile station to a PSAP that serves the location or serving cell for the mobile station. Furthermore, the processes may not impose any new requirements on the mobile station beyond an ability to support the origination of messages (e.g. SMS text messages) to different destination addresses. The user of mobile station 210 in process 300 in FIG. 3 and process 400 of FIG. 4 may compose the emergency message in the same manner as for any other message and enter an emergency number (e.g. 911, 112 or 999) for the destination address. Mobile station 210 may not be aware of the significance of this number and may send the emergency message to VMSC 224 just like any other message. In an alternative embodiment, mobile station 210 may provide additional support to the user for composing and sending the emergency message such as enabling inclusion of some particular pre-stored text (e.g. referring to a known medical condition or containing information about the user such as a home address or some friend, relative or a doctor who can be contacted), which may have been entered by the user and stored at some previous time. Mobile station 210 may also allow the user to indicate the emergency destination number in some simple explicit manner such as by selecting the address from a menu or by pressing a particular key or combination of keys.

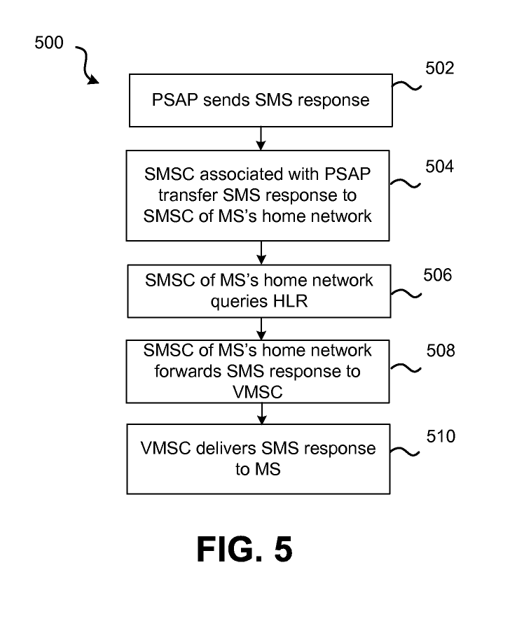

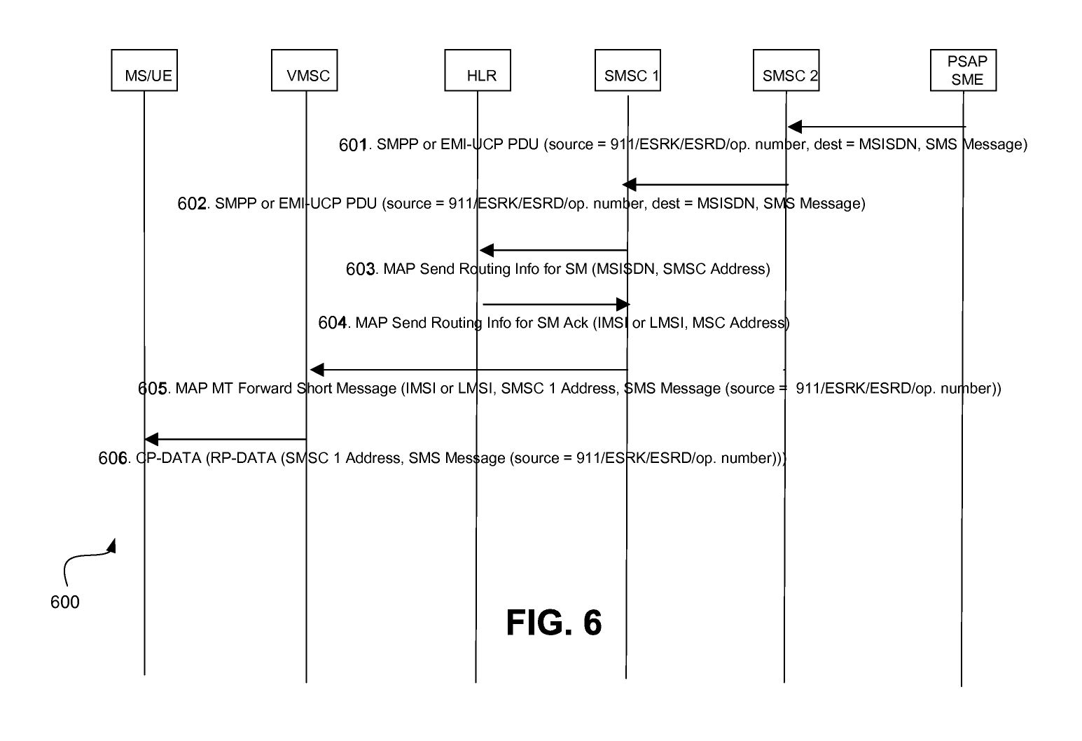

Having sent an emergency message as described in FIGS. 3 and 4, it may be a further advantage to the user and PSAP if the destination PSAP is able to send back a reply. FIGS. 5 and 6 describe exemplary embodiments for such support. FIG. 5 is a simplified flow diagram, illustrating a process 500 for the routing of a response according to one embodiment. An SMS message is used for illustration purposes; however, other non-real time messages may be used for communicating with the emergency service provider. The process 500 is performed by processing logic that comprises hardware (circuitry, dedicated logic, etc.), software (such as is run on a general purpose computing system or a dedicated machine), firmware (embedded software), or any combination thereof. In one embodiment, the process 500 is performed by one or more computer systems 2100 as described in FIG. 21. Process 500 may start some time after one or more SMS messages have been transferred from mobile station 210 to PSAP 240 according to FIGS. 3 and 4. Process 500 may be invoked when PSAP 240 wishes to send a response message to the user of mobile station 210.

Process 500 begins at step 502 with PSAP 240 (e.g. SME 248 in PSAP 240) constructing an SMS response to mobile station 210. In some embodiments, the response includes the mobile station's 210 MSISDN received in step 314 of process 300 and/or in step 407 of FIG. 4 as the destination address. The response may additionally include a general emergency number (e.g. 911) or the ESRK or ESRD or an operator specific number as the source address. In some embodiments, the response is initially transferred by PSAP SME 248 to an SMSC associated with PSAP 240 (e.g., SMSC 246)—e.g. using an IP based transport protocol, such as SMPP or EMI-UCP. In other embodiments, the response may be transferred directly to SMSC 234. At step 504, SMSC 246 transfers the SMS response to SMSC 234—e.g. using an IP based transport protocol, such as SMPP or EMI-UCP. At step 506, SMSC 234 queries HLR 232 for both the address of VMSC 224 and mobile station 210's IMSI or an LMSI. At step 508, SMSC 234 forwards the SMS response to VMSC 224 together with the IMSI or LMSI. At step 510, VMSC 224 delivers the SMS response to mobile station 210 which is identified by the IMSI or LMSI. Mobile station 210 may use the received source address as the destination address for future SMS messages sent to the PSAP operator. Since this will either be the ESRK, ESRD, an operator specific address or an emergency number, the SMS message will be routed correctly. (In the case of an emergency number, steps 401 to 407 in FIG. 4 would be used, and for an ESRK, ESRD or operator specific number, the normal SMS delivery procedure would be used.)

It should be appreciated that the specific steps illustrated in FIG. 5 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process 500.

FIG. 6 is a signaling flow diagram illustrating the communications exchanged between various entities in order to route a response to according to one embodiment. FIG. 6 is a signaling flow diagram for the flow described with respect to FIG. 5. An SMS message is used for illustration purposes; however, other non-real time messages may be used for communicating with the emergency service provider. The process 600 is performed by processing logic that comprises hardware (circuitry, dedicated logic, etc.), software (such as is run on a general purpose computing system or a dedicated machine), firmware (embedded software), or any combination thereof. In one embodiment, the process 600 is performed by one or more computer systems 2100 as described in FIG. 21.

Process 600 begins at step 601 with PSAP 240 (e.g. SME 248 in PSAP 240) constructing an SMS response for mobile station 210. In some embodiments, the response includes the mobile station's 210 MSISDN received in step 314 of process 300 and/or in step 407 of FIG. 4 as the destination address. The response may additionally include a general emergency number (e.g. 911) or the ESRK or ESRD or an operator specific number as the source address. In some embodiments, the response is initially transferred by PSAP SME 248 to an SMSC associated with PSAP 240 (e.g., SMSC 246)—e.g. using an IP based transport protocol, such as SMPP or EMI-UCP. In other embodiments, the response may be transferred directly to SMSC 234. At step 602, SMSC 246 transfers the SMS response to SMSC 234—e.g. using an IP based transport protocol, such as SMPP or EMI-UCP. PSAP 240 or SMSC 246 may identify and route to SMSC 234 based on leading digits in the destination MSISDN address which may be unique to the home network 230 of mobile station 210. At step 603 and step 604, SMSC 234 queries HLR 232 for both the address of VMSC 224 and mobile station 210's IMSI or an LMSI. At step 605, SMSC 234 forwards the SMS response to VMSC 224 and includes the IMSI or LMSI. At step 607, VMSC 224 delivers the SMS response to mobile station 210 which is identified using the IMSI or LMSI. Mobile station 210 may use the received source address as the destination address for future SMS messages sent to the PSAP operator. Since this will either be the ESRK, ESRD, an operator specific address or an emergency number, the SMS message will be routed correctly. (In the case of an emergency number, steps 401 to 407 in FIG. 4 would be used, and for an ESRK, ESRD or operator specific number, the normal SMS delivery procedure would be used).

It should be appreciated that the specific steps illustrated in FIG. 6 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process 600.

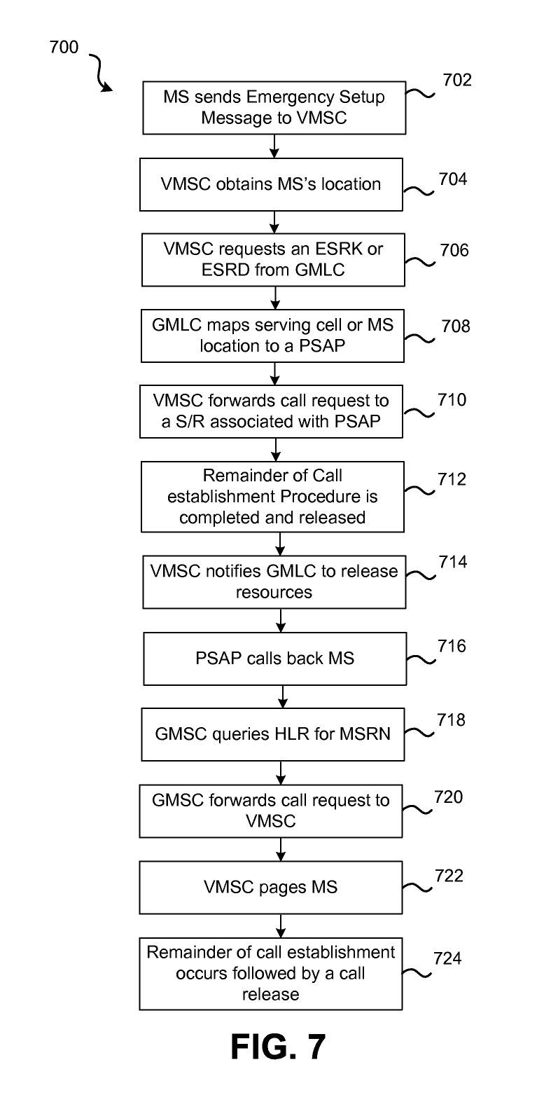

FIGS. 3, 4, 5, and 6 describe exemplary embodiments in which emergency related messages may be exchanged between the user of a mobile station and a PSAP operator. It may be a further advantage to the user and PSAP operator if the user or PSAP is enabled to originate an emergency related voice call to the other party before, during or after the emergency related messages have been exchanged. Exemplary embodiments enabling this are described herein in association with FIGS. 7 and 8. FIG. 7 is a flow diagram of a process 700 for providing emergency CS Calls and callbacks in parallel to an emergency SMS. An SMS message is used for illustration purposes; however, other non-real time messages may be used for communicating with the emergency service provider. The process 700 is performed by processing logic that comprises hardware (circuitry, dedicated logic, etc.), software (such as is run on a general purpose computing system or a dedicated machine), firmware (embedded software), or any combination thereof. In one embodiment, the process 700 is performed by one or more computer systems 2100 as described in FIG. 21.

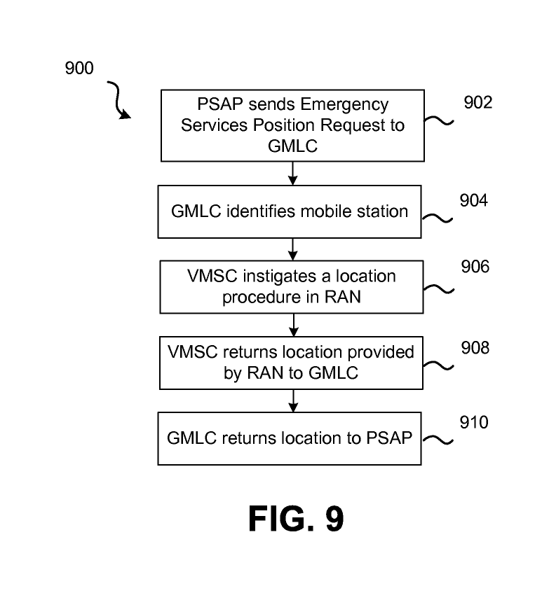

Process 700 begins at step 702 with mobile station 210 sending an Emergency SETUP message, or a CM Service Request message carrying an emergency indication, to VMSC 224 to request an emergency CS (e.g. voice) call. This may occur before or after any emergency SMS messages are sent. At step 704, VMSC 224 may obtain the mobile station's 210 location—e.g. by sending a location request to RAN 222 which may then invoke positioning of mobile station 210 (e.g. using A-GPS, A-GNSS, OTDOA, AFLT, E-CID, or other method) and return the obtained location to VMSC 224. At step 706, if VMSC 224 already has an ESRK or ESRD for mobile station 210 due to sending a previous emergency SMS message as described in FIGS. 3 and 4, VMSC 224 may use the same ESRK and ESRD for call routing and may skip steps 704, 706 and 708. Otherwise, at step 706, if VMSC 224 does not yet have an ESRK or ESRD for mobile station 210, VMSC 224 requests an ESRK or ESRD from GMLC 226 and includes in the request the mobile station 210's IMSI, MSISDN, serving cell and location if available. At step 708, GMLC 226 maps the serving cell or mobile station location to PSAP 240 (e.g., a PSAP that services that location or cell area). GMLC 226 additionally assigns an ESRK or ESRD that identifies the PSAP (as well as GMLC 226) and returns the ESRK or ESRD to VMSC 224. GMLC 226 stores mobile station's 210 IMSI, MSISDN, ESRK or ESRD, serving cell, location if available and the VMSC address. At step 710, VMSC 224 forwards the call request in an SS7 ISUP IAM message to PSAP selective router 242 (S/R). VMSC 224 may select S/R 242 according to the ESRK or ESRD. For an ESRK, the ISUP called Party Number may be set by VMSC 224 to an emergency number (e.g. 911) and the ISUP Calling Party Number may be set to the ESRK. S/R 242 uses the ESRK to determine the PSAP (e.g., PSAP 240) and routes the call to the PSAP (e.g. to ESNE 244 in PSAP 240) but may only signal the ESRK. PSAP 240 can obtain the MSISDN (e.g. to call back mobile station 210 in steps 716 to 724) by performing process 900 shown in FIG. 9 and/or the signaling shown in FIG. 10 after the call is established in step 712 and before callback occurs in step 716. For an ESRD, the ISUP Called Party Number may be set by VMSC 224 to an emergency number (e.g. 911) or the ESRD; the ISUP calling Party Number may be set to mobile station 210's MSISDN; and the ISUP Generic Digits Parameter (GDP) may be set to the ESRD. S/R 242 may then use the ESRD in the GDP to determine the PSAP (e.g., PSAP 240) and forwards the call to the PSAP (e.g. to ESNE 244 in PSAP 240) including the MSISDN and ESRD. At step 712, the remainder of the call establishment procedure is completed and some time later the call is released. At step 714, after the CS EMC is released and after some interval following the last emergency SMS message from mobile station 210 if emergency SMS messages are being sent, VMSC 224 notifies GMLC 226 that any resources such as the ESRK can be released.

At step 716, PSAP 240 may call back mobile station 210. If this is so, PSAP 240 sends a call request (e.g. ISUP IAM message) to GMSC 236 (e.g., a GMSC in mobile station 210's home network 230)—possibly via an S/R and/or the PSTN; the call request is routed using the mobile station's MSISDN. This step may occur following steps 702 to 712 in FIG. 7 or following steps 302 to 314 in FIG. 3 (i.e. the PSAP may call back the mobile station after an emergency SMS message is received), for example. At step 718, GMSC 236 queries HLR 232 for a routing number (MSRN) using mobile station's 210 MSISDN. HLR 232 in turn queries VMSC 224, which returns the MSRN. At step 720, GMSC 226 forwards the call request to VMSC 224 using the MSRN for routing. At step 722, VMSC 224 recognizes the call is for mobile station 210 from the MSRN, and pages the mobile station. At step 724, the remainder of the call establishment occurs followed some time later by a call release.

In one embodiment of process 700, when step 702 occurs after one or more emergency SMS messages have been sent by mobile station 210 to PSAP 240 according to process 300 in FIG. 3 or process 400 in FIG. 4 and/or before VMSC 224 requests GMLC 226 to release any ESRK or ESRD (e.g. as in steps 408 and 409 of FIG. 4), VMSC 224 and PSAP S/R 242 may use the same ESRK or ESRD for routing the emergency call in step 710 as were used to route the earlier emergency SMS messages (e.g. in steps 405, 406 and 407 of FIG. 4). If process 700 occurs before mobile station 210 sends an emergency SMS message to PSAP 240 according to process 300 in FIG. 3 and process 400 in FIG. 4, VMSC 224 may include the same ESRK or ESRD as the destination address for the emergency SMS message in step 310 of process 300 and step 405 of FIG. 4 as was used to route the CS emergency call in step 710 of process 700. Thus, regardless of whether a CS emergency call occurs before an emergency SMS transfer or afterwards, both the emergency call and the emergency SMS messages can be sent to the same PSAP 240. In addition, if PSAP 240 records the ESRK or the ESRD and the mobile station 210 MSISDN together with the identity of the PSAP operator, PSAP 240 (by retrieving the operator identity) can send the CS emergency call and the emergency SMS message(s) to the same PSAP operator. This may be a significant advantage in ensuring that all emergency communication from the same user is seen by the same operator.

It should be appreciated that the specific steps illustrated in FIG. 7 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 7 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process 700.

FIG. 8 shows the communications exchanged between various entities in order to provide emergency CS Calls and callbacks according to the embodiment. FIG. 8 is a signaling flow diagram for the flow described with respect to FIG. 7. An SMS message is discussed below for illustration purposes; however, other non-real time messages may be used for communicating with the emergency service provider. The process 800 is performed by processing logic that comprises hardware (circuitry, dedicated logic, etc.), software (such as is run on a general purpose computing system or a dedicated machine), firmware (embedded software), or any combination thereof. In one embodiment, the process 800 is performed by one or more computer systems 2100 as described in FIG. 21.

Process 800 begins at step 801 with mobile station 210 sending an Emergency SETUP message to VMSC 224 to request an emergency CS (e.g. voice) call. This may occur before or after any emergency SMS messages are sent. At step 802, VMSC 224 may obtain the mobile station's 210 location—e.g. by sending a location request to RAN 222 which may then invoke positioning of mobile station 210 (e.g. using A-GPS, A-GNSS, OTDOA, AFLT, E-CID, or other method) and return the obtained location to VMSC 224. At step 803, if VMSC 224 already has an ESRK or ESRD for mobile station 210 due to sending a previous emergency SMS message as described in FIGS. 3 and 4, VMSC 224 may use the same ESRK and ESRD for call routing and may skip steps 802, 803 and 804. Otherwise, at step 803, if VMSC 224 does not yet have an ESRK or ESRD for mobile station 210, VMSC 224 requests an ESRK or ESRD from GMLC 226 and includes in the request the mobile station's 210 IMSI, MSISDN, serving cell and location if available. At step 804, GMLC 226 maps the serving cell or mobile station location to PSAP 240 (e.g., a PSAP that services that location or cell area). GMLC 226 additionally assigns an ESRK or ESRD that identifies the PSAP (as well as GMLC 226) and returns the ESRK or ESRD to VMSC 224. GMLC 226 stores mobile station's 210 IMSI, MSISDN, ESRK or ESRD, serving cell, location if available and the VMSC 224 address. At step 805, VMSC 224 forwards the call request in an SS7 ISUP IAM message to PSAP selective router 242 (S/R). VMSC 224 may determine S/R 242 using the ESRK or ESRD. For an ESRK, the ISUP called Party Number is set by VMSC 224 to an emergency number (e.g. 911) and the ISUP Calling Party Number is set to the ESRK. S/R 242 uses the ESRK to determine the PSAP (e.g., PSAP 240) and signals the call to the PSAP but sends only the ESRK. PSAP 240 can obtain the MSISDN (e.g. to call back mobile station 210 in steps 809 to 816) by performing process 900 shown in FIG. 9 and/or the signaling shown in FIG. 10 after the call is established in step 806 and before callback occurs in step 809. For an ESRD, the ISUP Called Party Number may be set by VMSC 224 to an emergency number (e.g. 911) or the ESRD; the ISUP calling Party Number may be set to mobile station's 210 MSISDN; and the ISUP Generic Digits Parameter (GDP) may be set to the ESRD. S/R 242 uses the ESRD in the GDP to determine the PSAP (e.g., PSAP 240) and forwards the call to the PSAP (e.g. to ESNE 244 in PSAP 240) including the MSISDN and ESRD. At step 806, the remainder of the call establishment procedure is completed and sometime later the call is released. At steps 807 and 808, after the CS EMC is released and after some interval following the last emergency SMS message from mobile station 210 if emergency SMS messages are being sent, VMSC 224 notifies GMLC 226 that any resources such as the ESRK and items stored in step 804 can be released.

At step 809, PSAP 240 may call back mobile station 210. If this is so, PSAP 240 (e.g. ESNE 244 in PSAP 240) sends a call request (e.g. ISUP IAM message) to GMSC 236 (e.g., a GMSC in mobile station's 210 home network 230)—possibly via an S/R and/or the PSTN; the call request is routed using the mobile station's MSISDN. This step may occur following steps 801 to 806 in FIG. 8 or following steps 302 to 314 in FIG. 3 (i.e. the PSAP may call back the mobile station after an emergency SMS message is received), for example. At steps 810, 811, 812 and 813, the GMSC 236 queries HLR 232 for a routing number (MSRN) using mobile station 210's MSISDN. HLR 232 in turn queries VMSC 224, which returns the MSRN. At step 814, GMSC 236 forwards the call request to VMSC 224 using the MSRN for routing. At step 815, VMSC 224 recognizes the call is for mobile station 210 from the MSRN, and pages the mobile station. At step 816, the remainder of the call establishment occurs followed some time later by a call release.

In an embodiment of FIG. 8, when step 801 occurs after one or more emergency SMS messages have been sent by mobile station 210 to PSAP 240 according to process 300 of FIG. 4 or process 400 of FIG. 4 and/or before VMSC 224 requests GMLC 226 to release any ESRK or ESRD (e.g. as in steps 408 and 409 of FIG. 4), VMSC 224 and PSAP S/R 242 may use the same ESRK or ESRD for routing the emergency call in step 805 as were used to route the earlier emergency SMS messages (e.g. in steps 405, 406 and 407 of FIG. 4). If steps 801 to 806 occur before mobile station 210 sends an emergency SMS message to PSAP 240 according to process 300 in FIG. 3 and process 400 in FIG. 4, VMSC 224 may include the same ESRK or ESRD as the destination address for the emergency SMS message in step 310 of process 300 and step 405 of FIG. 4 as was used to route the CS emergency call in step 805 of FIG. 8. Thus, regardless of whether a CS emergency call occurs before an emergency SMS transfer or afterwards, both the emergency call and the emergency SMS messages can be sent to the same PSAP 240. In addition, if PSAP 240 records the ESRK or the ESRD and the mobile station 210 MSISDN together with the identity of the PSAP operator, PSAP 240 (by retrieving the operator identity) can send the CS emergency call and the emergency SMS message(s) to the same PSAP operator. This may be a significant advantage in ensuring that all emergency communication from the same user is seen by the same operator.

It should be appreciated that the specific steps illustrated in FIG. 8 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 8 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process 800.

FIGs. 3, 4, 5, 6, 7 and 8 describe embodiments that support emergency related communication in the form of messages and voice calls between the user of a mobile station and a PSAP operator. Often, the PSAP operator will want to know where the user is located—e.g. to dispatch public safety assistance to the user in the form of police, fire services, ambulance, mountain rescue or some other service. However, the location of the user (i.e. of mobile station 210) may sometimes be unknown exactly to the user (hence cannot be directly communicated either by voice or messaging) or the user may not be in a condition to communicate this (e.g. may be delirious or unable to speak or type much), Furthermore, delivery of emergency messages as described in FIGS. 3 and 4 and delivery of an emergency voice call as described in FIGS. 7 and 8 may not provide any location related information additional to the ESRK or ESRD. While the ESRK or ESRD may have been derived using the location or serving cell of the mobile station, the ESRK or ESRD may still be associated with a large area (e.g. containing many cells or many small location areas). Hence, there will be a benefit in enabling the PSAP to obtain an accurate location for the mobile station following transfer of an emergency message or establishment of an emergency voice call in association with transfer of emergency messages. FIGS. 9 and 10 describe exemplary embodiments to support this.

FIG. 9 is a simplified flow diagram illustrating a process 900 for performing a location procedure used to support emergency SMS messaging and CS emergency calls according to one embodiment. An SMS message is discussed below for illustration purposes; however, other non-real time messages may be used for communicating with the emergency service provider. The process 900 is performed by processing logic that comprises hardware (circuitry, dedicated logic, etc.), software (such as is run on a general purpose computing system or a dedicated machine), firmware (embedded software), or any combination thereof. In one embodiment, the process 900 is performed by one or more computer systems 2100 as described in FIG. 21.

It may be beneficial for PSAP 240 to have or obtain an accurate initial location estimate for mobile station 210 or an updated location estimate—e.g. after receiving an emergency SMS message and before receiving any CS EMC. Process 900 may be invoked by PSAP 240 after receiving an emergency SMS message—e.g. as in step 314 in FIG. 3 or step 407 of FIG. 4. Process 900 begins at step 902 with PSAP 240 (e.g. ESME 250 in PSAP 240) sending an Emergency Services Position Request to GMLC 226 (the GMLC identified by the ESRK or ESRD received in an earlier SMS message (e.g. in step 314 of FIG. 3) or with an earlier CS EMC (e.g. in step 710 of FIG. 7)). PSAP 240 includes in the request the ESRK or MSISDN plus ESRD (e.g. as received in step 314 of FIG. 3). PSAP 240 may distinguish an ESRK from an ESRD (e.g. received in step 314 of FIG. 3) by knowing in advance (e.g. from configuration information) the different number ranges used for ESRKs and for ESRDs. This may enable PSAP 240 to correctly populate the ESRD or ESRK parameter in the request sent to GMLC 226. At step 904, GMLC 226 identifies mobile station 210 and VMSC 224 from the ESRK or MSISDN plus ESRD received in step 902 using the information previously stored in step 308 of FIG. 3 or step 708 of FIG. 7. In some embodiments, GMLC may skip steps 906 and 908 and return any location stored earlier—e.g. in step 308 of FIG. 3 or step 708 of FIG. 7—if this location meets the accuracy requirement of PSAP 240. In some other embodiments, GMLC 226 forwards the location request to VMSC 224. In certain embodiments, the request includes the IMSI and/or MSISDN stored and received earlier from VMSC 224. At step 906, VMSC 224 instigates a location procedure in RAN 222 to obtain mobile station's 210 location—e.g. as defined in 3GPP Technical Specifications (TSs) 23.271, 43.059 and 25.305 and possibly making use of A-GPS, A-GNSS, OTDOA, AFLT, or E-CID positioning, or other such positioning. At step 908, VMSC 224 returns the location provided by RAN 222 in step 906 to GMLC 226. At step 910, GMLC 226 returns the location to PSAP 240. GMLC 226 may also return the MSISDN of mobile station 210 to PSAP 240 if the PSAP 240 request in step 902 included an ESRK.

It should be appreciated that the specific steps illustrated in FIG. 9 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 9 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process 900.

FIG. 10 is a diagram of a process 1000 illustrating the communications exchanged between various entities in order to perform a location procedure used to support emergency SMS messaging according to one embodiment. FIG. 10 is a signaling flow diagram for the flow described with respect to FIG. 9. An SMS message is discussed below for illustration purposes; however, other non-real time messages may be used for communicating with the emergency service provider. The signaling in process 1000 is performed by processing logic that comprises hardware (circuitry, dedicated logic, etc.), software (such as is run on a general purpose computing system or a dedicated machine), firmware (embedded software), or any combination thereof. In one embodiment, the process 1000 is performed by one or more computer systems 2100 as described in FIG. 21.

It is desirable that PSAP 240 has an accurate initial location estimate for mobile station 210 or an updated location estimate—e.g. after receiving an emergency SMS message and before receiving any CS EMC. The signaling in FIG. 10 may be invoked by PSAP 240 after receiving an emergency SMS message—e.g. as in step 314 in FIG. 3 or step 407 of FIG. 4. FIG. 10 begins at step 1001 with PSAP 240 (e.g. to ESME 250 in PSAP 240) sending an Emergency Services Position Request to GMLC 226 (the GMLC identified by the ESRK or ESRD received in an earlier SMS message (e.g. in step 314 of FIG. 3) or with an earlier CS EMC (e.g. in step 710 of FIG. 7)). The PSAP 240 includes in the request the ESRK or MSISDN plus ESRD (e.g. as received in step 407 of FIG. 4). PSAP 240 may distinguish an ESRK from an ESRD (e.g. received in step 407 of FIG. 4) by knowing in advance (e.g. from configuration information) the different number ranges used for ESRKs and for ESRDs. This may enable PSAP 240 to correctly populate the ESRD or ESRK parameter in the request sent to GMLC 226 in step 1001. At step 1002, GMLC 226 identifies mobile station 210 and VMSC 224 from the ESRK or MSISDN plus ESRD received in step 1001 using the information previously stored in step 404 of FIG. 4 or step 804 of FIG. 8. In some embodiments, GMLC may skip steps 1002, 1003 and 1004 and return any location stored earlier—e.g. in step 404 of FIG. 4 or step 804 of FIG. 8—if this location meets the accuracy requirement of PSAP 240. In some other embodiments, in step 1002, GMLC 226 forwards the location request to VMSC 224. In certain embodiments, the request includes the IMSI and/or MSISDN stored and received earlier from VMSC 224. At step 1003, VMSC 224 instigates a location procedure in RAN 222 to obtain mobile station's 210 location—e.g. as defined in 3GPP TSs 23.271, 43.059 and 25.305 and possibly making use of A-GPS, A-GNSS, OTDOA, AFLT, or E-CID positioning, or other such positioning. At step 1004, VMSC 224 returns the location provided by RAN 222 in step 1003 to GMLC 226. At step 1005, GMLC 226 returns the location to PSAP 240. GMLC 226 may also return the MSISDN of mobile station 210 to PSAP 240 if the PSAP 240 request in step 1001 included an ESRK.

It should be appreciated that the specific steps illustrated in FIG. 10 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 10 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process 1000.

With regard to the processes shown in FIGS. 3-10 and as discussed, after the VMSC has obtained an ESRK or ESRD from the GMLC, the VMSC can use the ESRK or ESRD to route subsequent SMS messages and any CS EMC to the same PSAP operator. If an ESRK is used, the ESRK is only released following some time period of no emergency SMS or CS EMC activity from the mobile station. Furthermore, the PSAP can store the ESRK or ESRD and MSISDN and use these to direct any subsequent SMS messages and/or CS EMC from the same mobile station to the same PSAP operator. The PSAP can additionally use the ESRK or ESRD to identify the GMLC and can use the ESRK or the ESRD plus MSISDN to identify the mobile station to the GMLC whenever it requests the mobile station location or (if an ESRK is being used) the mobile station MSISDN.

The embodiments described in FIGS. 2-10 may apply to wireless networks defined by 3GPP such as GSM, WCDMA and LTE networks and make use of existing 3GPP standards for SMS support applicable to the UE, VMSC, SMSC, HLR and PSAP, existing standards for CS EMC support applicable to the UE, VMSC, GMLC, GMSC and PSAP and existing standards for location support applicable to the P SAP, GMLC, VMSC, RAN and UE. Exemplary impact to existing standards that may be applicable to a VMSC include: recognition of emergency SMS messages; obtaining an ESRK or ESRD from a GMLC (using an existing MAP procedure); substituting the ESRK or ESRD in the SMS message as the destination address; sending the SMS message to an SMSC; making use of an already obtained ESRK or ESRD to support a subsequent CS EMC or further emergency SMS messages. In some embodiments, as an alternative to requesting an ESRK or ESRD from a GMLC, the VMSC could assign the ESRK or ESRD itself and include this in the MAP Subscriber Location Report sent to the GMLC in step 306 of FIG. 3 and step 706 of FIG. 7. Those of skill in the art will appreciate that the embodiments described in FIGS. 2-10 may also apply to wireless networks other than those described above.

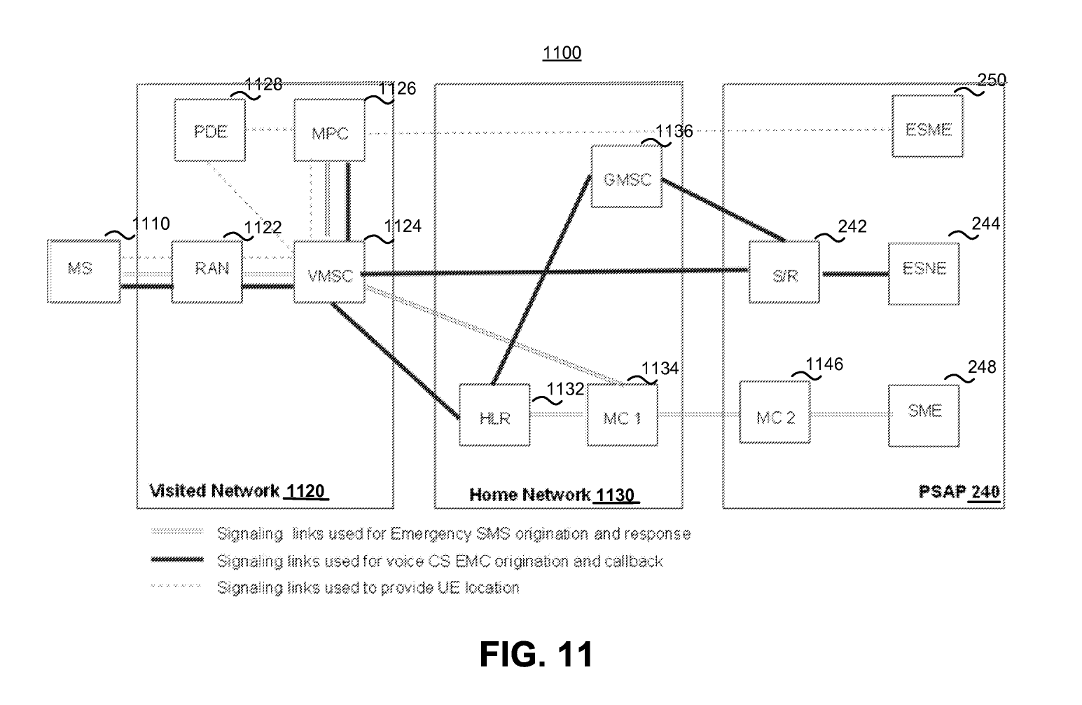

FIG. 11 illustrates a system 1100 for supporting emergency SMS messaging according to another embodiment which may apply to wireless networks defined by 3GPP2 such as CDMA2000 1xRTT and HRPD networks. In some embodiments, the embodiment may apply to other types of wireless networks. In some embodiments, other non-real time messages, such as messages which are delay tolerant messages, may be utilized. In some embodiments, text messages which do not conform to SMS may also be utilized, as may picture or audio and/or video messages or other types of multimedia messages, for example. System 200 can be used within a 3GPP or other communication networks. System 1100 can be similar to system 200 shown in FIG. 2, except that system 1100 can be configured to support 3GPP2 (e.g. 1xRTT) networks. For example, SMS messages addressed to an emergency number (e.g. 911, 112) can be routed to a PSAP using an ESRK or ESRD, as with system 200. The VMSC, however, can be configured to obtain the ESRK or ESRD after detecting the first originated emergency SMS message. Location support in system 1100 can reuse the location solution used for 3GPP2 CS EMCs. In some embodiments, a CS EMC can be routed to the same PSAP selected for previous emergency SMS messages using a previously obtained ESRK or ESRD. In addition to the various entities described in FIG. 2, other entities discussed in FIG. 11, such as PDE 1128, MPC 1126, MC 1 (block 1134), and MC 2 (block 1146), may be implemented using the computer system 2100 or components of the computer system 2100 as described in FIG. 21.

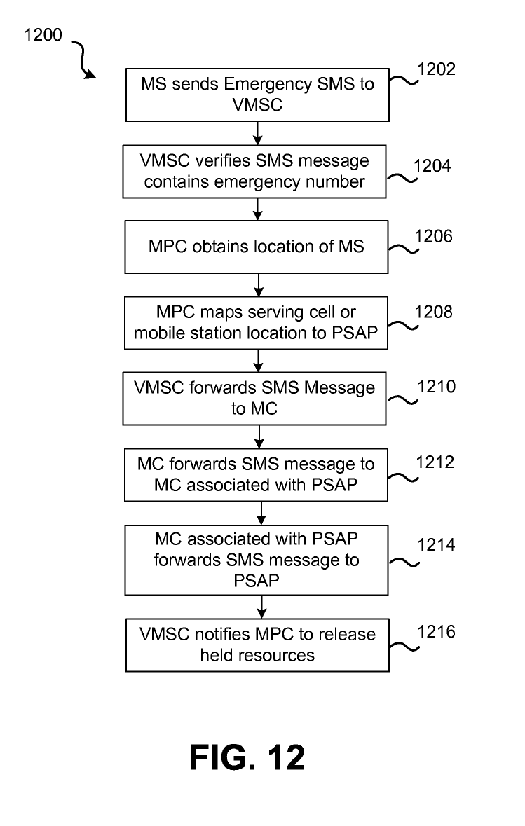

The following entities of system 1100 and system 200 may be considered functionally equivalent: all entities sharing the same abbreviation (e.g. MS 210 and 1110, RAN 222 and 1122, VMSC 224 and 1124, HLR 232 and 1132, GMSC 236 and 1136); GMLC 226 and MPC 1126; SMSC 234 and MC 1134; SMSC 246 and MC 1146; and SAS/SMLC 228 and PDE 1128. These entities may be implemented using a computer system similar to FIG. 21 or using components of a computer system described in FIG. 21. Examples of processes that can be used to provide emergency services based on SMS messaging will now be described. The processes shown in FIGS. 12-19 can be performed by the various entities shown in system 1100 of FIG. 11.

FIG. 12 is a simplified flow diagram illustrating a process 1200 for the routing of an SMS message to an emergency service according to one embodiment. An SMS message is discussed below for illustration purposes; however, other non-real time messages may be used for communicating with the emergency service provider. The process 1200 is performed by processing logic that comprises hardware (circuitry, dedicated logic, etc.), software (such as is run on a general purpose computing system or a dedicated machine), firmware (embedded software), or any combination thereof. In one embodiment, the process 1200 is performed by one or more computer systems 2100 as described in FIG. 21.

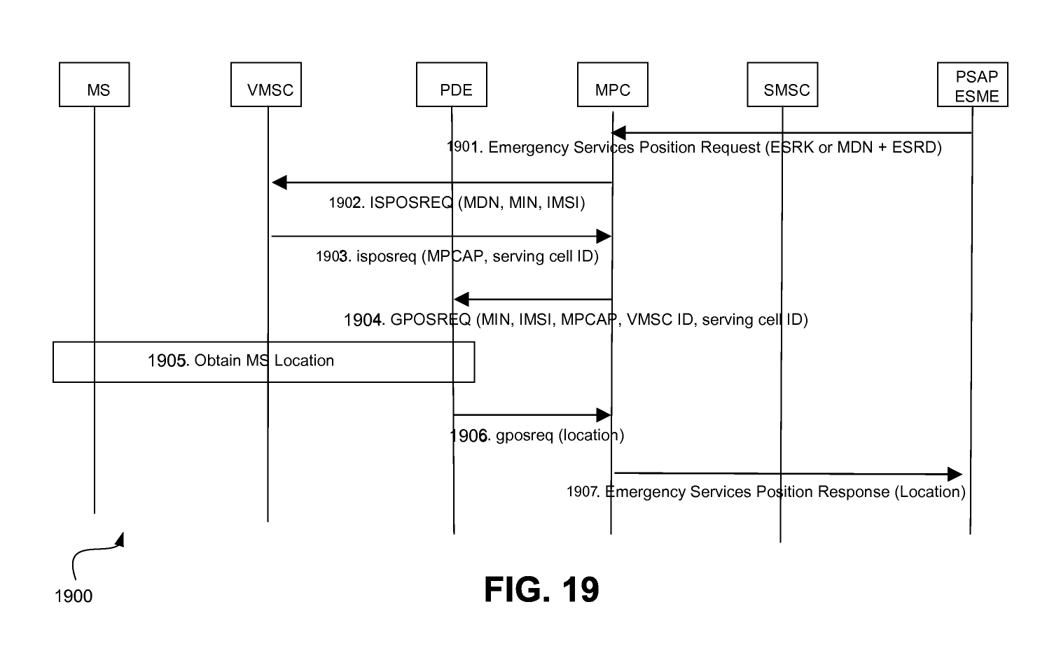

Process 1200 begins at step 1202 with mobile station 1110 sending an emergency SMS message to the VMSC 1124. The SMS message can be accompanied by the address of MC 1134 and an emergency destination address (e.g., 911 or 112). At step 1204, VMSC 1124 verifies that the SMS message is associated with an emergency destination number (e.g. 911, 112). Thereafter, in the event the VMSC does not yet have an ESRK or ESRD for mobile station 1110, VMSC 1124 sends an Origination Request (ORREQ) to MPC 1126 for an ESRK or ESRD. The request includes mobile station 1110's MSID, MDN, mobile positioning capabilities (MPCAP) and serving cell ID (if known) as well as an identifier (MSC ID) for VMSC 1124. At step 1206, MPC 1126 obtains the location of mobile station 1110 by sending a request to PDE 1128, which may then interact with mobile station 1110 using the IS-801 positioning protocol (as shown in steps 1904 to 1906 in FIG. 19). At step 1208, MPC 1126 maps the serving cell ID or mobile station location to a PSAP (e.g., PSAP 240) that services that location or cell area. MPC 1126 thereafter assigns an ESRK or determines an ESRD that identifies the PSAP (as well as MPC 1126) and returns the ESRK or ESRD to VMSC 1124. In some embodiments, MPC 1126 stores mobile station 1110's MSID, MDN, ESRK or ESRD, serving cell ID, location if available and the MSC ID.

At step 1210, VMSC 1124 forwards the SMS message to MC 1134 in a MAP SMSDeliveryPointToPoint (SMDPP) message. The SMDPP can include the ESRK or ESRD as the destination address and the MSID and MDN of mobile station 1110. At step 1212, MC 1134 may, in some embodiments, forward the SMS message to MC 1146 that supports destination PSAP 240. In other embodiments, MC 1134 may forward the SMS message directly to PSAP 240. In the former embodiment, MC 1134 may use an IP based protocol like SMPP or EMI-UCP or send an SMDPP message to MC 1146 carrying the SMS message, the ESRK or ESRD identifying PSAP 240, and mobile station's 1110 MDN, for example. At step 1214, MC 1146 forwards the SMS message to PSAP 240 (e.g. to SME 248 in PSAP 240). In some embodiments, PSAP 240 can be identified by the ESRK or ESRD—e.g., by using an IP based protocol like SMPP or EMI-UCP. At step 1216, following some interval during which no new emergency SMS messages are sent by mobile station 1110 and provided there is no CS EMC, VMSC 1124 notifies MPC 1126 that resources (e.g. the ESRK) can be released by sending a MAP Call Termination Report (CALLTERMREP) containing mobile station 1110's identity (MSID).

In some embodiments, steps 1202, 1210, 1212 and 1214 can be repeated for further SMS messages with the VMSC 1124 using the same ESRK or ESRD in step 1210—the PSAP can use the ESRK/ESRD and MDN in each received SMS message to pass each message to the same operator. As an alternative to steps 1210, 1212 and 1214, the VMSC could send each emergency SMS message directly to the PSAP and bypass the MCs thereby reducing delay but adding additional impacts to the VMSC or the VMSC could send each emergency SMS message to an MC in the visited network or to the MC (MC 1146) associated with the PSAP that is dedicated to transferring emergency SMS messages.

It should be appreciated that the specific steps illustrated in FIG. 12 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 12 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process 1200.

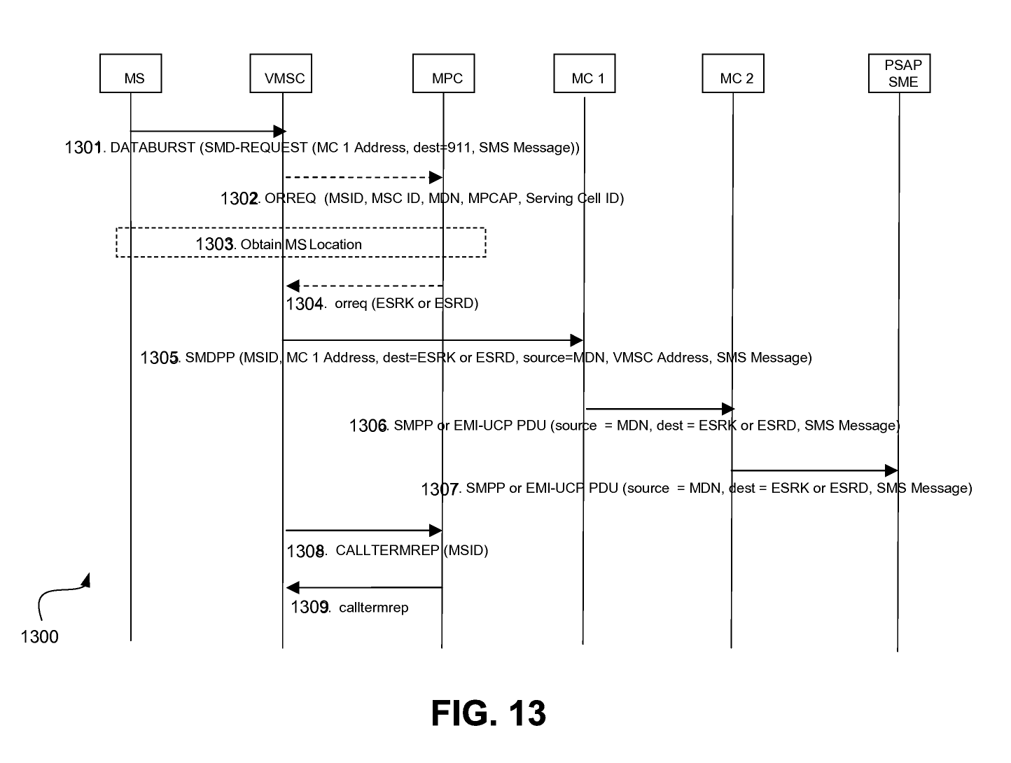

FIG. 13 is a diagram illustrating the communications exchanged between various entities in order to route an SMS message to an emergency service according to one embodiment. FIG. 13 is a signaling flow diagram for the flow described with respect to FIG. 12. An SMS message is discussed below for illustration purposes; however, other non-real time messages may be used for communicating with the emergency service provider. The process 1300 is performed by processing logic that comprises hardware (circuitry, dedicated logic, etc.), software (such as is run on a general purpose computing system or a dedicated machine), firmware (embedded software), or any combination thereof. In one embodiment, the process 1300 is performed by one or more computer systems 2100 as described in FIG. 21.

Process 1300 begins at step 1301 with mobile station 1110 sending an emergency SMS message to the VMSC 1124 inside an SMD-REQUST message. The SMS message can be accompanied by the address of MC 1134 and an emergency destination address (e.g., 911 or 112). At step 1302, VMSC 1124 verifies that the SMS message is associated with an emergency number (e.g. 911, 112). Thereafter, in the event the VMSC does not yet have an ESRK or ESRD for mobile station 1110, VMSC 1124 sends an Origination Request (ORREQ) to MPC 1126 for an ESRK or ESRD. The request includes mobile station's 1110 MSID, MDN, mobile positioning capabilities (MPCAP) and serving cell ID (if known) as well as an identifier (MSC ID) for VMSC 1124. At step 1303, MPC 1126 may obtain the location of mobile station 1110 by sending a request to PDE 1128, which may then interact with mobile station 1110 using the IS-801 positioning protocol (as shown in steps 1904 to 1906 in FIG. 19). At step 1304, MPC 1126 maps the serving cell ID (e.g. if step 1303 is not performed) or mobile station location to a PSAP (e.g., PSAP 240) that services that location or cell area. MPC 1126 thereafter assigns an ESRK or determines an ESRD that identifies the PSAP (as well as MPC 1126) and returns the ESRK or ESRD to VMSC 1124. In some embodiments, MPC 1126 stores mobile station 1110's MSID, MDN, ESRK or ESRD, serving cell, location if obtained and the MSC ID of VMSC 1124.

At step 1305, VMSC 1124 forwards the SMS message to MC 1134 in a MAP SMSDeliveryPointToPoint (SMDPP) message. The SMDPP can include the ESRK or ESRD as the destination address and the MSID and MDN of mobile station 1110 and the VMSC address. At step 1306, MC 1134 may, in some embodiments, forward the SMS message to MC 1146 that supports destination PSAP 240. In other embodiments, MC 1134 may forward the SMS message directly to PSAP 240. In the former embodiment, MC 1134 may use an IP based protocol like SMPP or EMI-UCP or send an SMDPP message to MC 1146 carrying the SMS message, the ESRK or ESRD identifying PSAP 240, and mobile station's 1110 MDN, for example. At step 1307, MC 1146 forwards the SMS message to PSAP 240 (e.g. to SME 248 in PSAP 240). In some embodiments, PSAP 240 can be identified by the ESRK or ESRD—e.g., by using an IP based protocol like SMPP or EMI-UCP. At step 1308 and step 1309, following some interval during which no new emergency SMS messages are sent by mobile station 1110 and provided there is no CS EMC, VMSC 1124 notifies MPC 1126 that resources (e.g. the ESRK) can be released by sending a MAP Call Termination Report (CALLTERMREP) containing mobile station's 1110 identity (MSID).

In some embodiments, steps 1301, 1305, 1306 and 1307 can be repeated for further SMS messages with the VMSC using the same ESRK or ESRD in step 1305—the PSAP can use the ESRK/ESRD and MDN in each received SMS message to pass each message to the same operator. As an alternative to steps 1305, 1306 and 1307, the VMSC could send each emergency SMS message directly to the PSAP and bypass the MCs thereby reducing delay but adding additional impacts to the VMSC or the VMSC could send each emergency SMS message to an MC in the visited network or to the MC (MC 1146) associated with the PSAP that is dedicated to transferring emergency SMS messages.

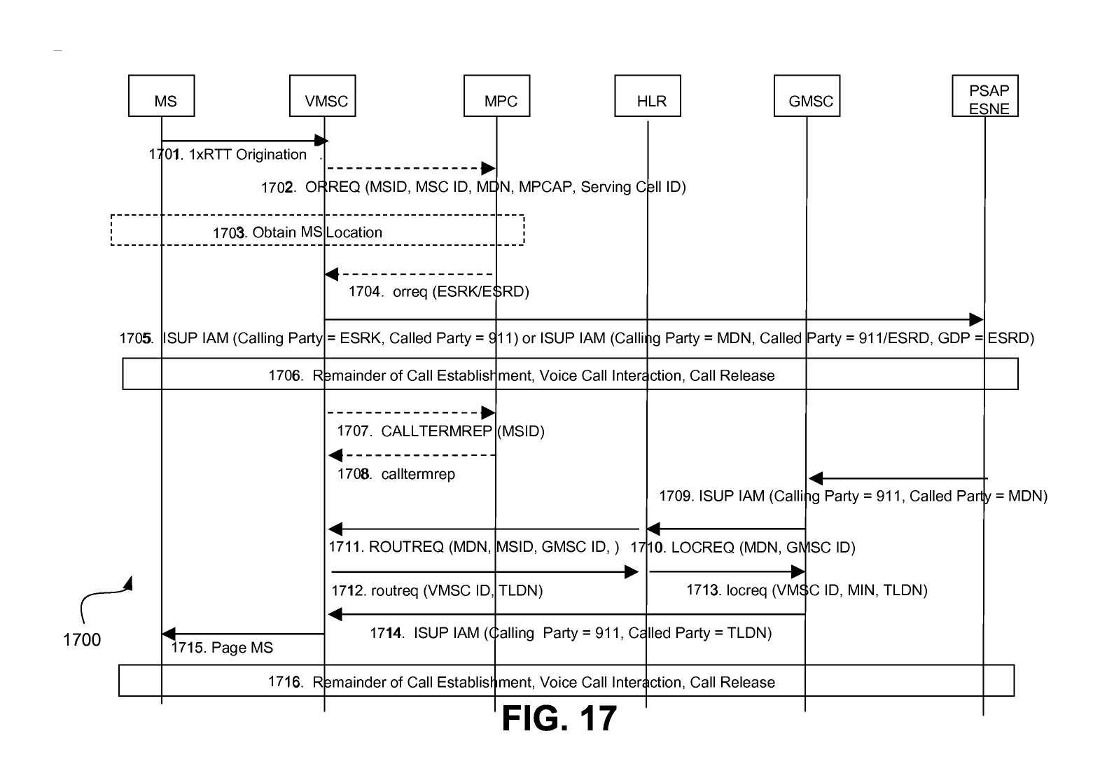

In some embodiments, determination that an SMS message sent from mobile station 1110 contains an emergency address may not be made at VMSC 1124 but may instead be made at the home MC 1134 for mobile station 1110. In that case, steps 1302, 1303 and 1304 in FIG. 13 may not be performed and the SMS message forwarded in step 1305 by VMSC 1124 in FIG. 13 may contain the emergency number inserted by mobile station 1110. When MC 1134 determines that the SMS message received in step 1305 contains an emergency number it may instigate steps similar to or the same as steps 1302 and 1304 to obtain an ESRK or ESRD from MPC 1126 and may then replace the emergency number in the SMS message with the received ESRK or ESRD. MPC 1126 may then record the ESRK or ESRD as well as the identity (e.g. MDN) of mobile station 1110 in order to return the same ESRK or ESRD, for example either (i) for any later query from MC 1134 for a subsequent SMS message sent from mobile station 1110 or (ii) for a query from VMSC 1124 related to a CS EMC (e.g. as in steps 1702 and 1704 of FIG. 17 described later herein). MC 1134 may further provide MPC 1126 with the address of VMSC 1124, for example which it may have received in step 1305, in order to allow MPC 1126 to query VMSC 1124 and PDE 1128 then or later (e.g. using steps the same as or similar to steps 1902 to 1906 in FIG. 19) for the location of mobile station 1110. In initially obtaining the ESRK or ESRD, MPC 1126 may use the service area of VMSC 1124 to determine PSAP 240 (and from this it may determine the ESRK or ESRD in some embodiments) or may query for the location or serving cell of mobile station 1110 from VMSC 1124 and possibly also from PDE 1128 (e.g. using steps similar to or the same as steps 1902, 1903 and possibly 1904 to 1906 in FIG. 19) and use the location or serving cell to determine PSAP 240. After MC 1134 has obtained the ESRK or ESRD from MPC 1126 and substituted this for the emergency number in the SMS message, MC 1134 may resume FIG. 13 as described above at step 1306. Steps 1308 and 1309 in this embodiment may be instigated by MC 1134 and not by VMSC 1124 to release the ESRK and/or any stored items in MPC 1126 after some time period during which no more SMS messages are sent by mobile station 1110. If further SMS emergency messages are sent by mobile station 1110, MC 1134 may, for example, (i) use the same ESRK or ESRD for routing as for the first message if MC 1134 has stored the ESRK or ESRD in association with mobile station 1110's identity (e.g. MDN) or MC 1134 may, for example, (ii) again query MPC 1126 for an ESRK or ESRD with MPC 1126 returning the same ESRK or ESRD as for the first SMS emergency message which MPC 1126 may retrieve from the association of the ESRK or ESRD with the mobile station 1110 identification (e.g. MDN). In this embodiment, impacts to VMSC 1124 may be reduced or eliminated but impacts may be increased in MC 1134 and MPC 1126. Further, the embodiment may be restricted in some implementations to cases where the visited and home networks 1120 and 1130 are the same.

It should be appreciated that the specific steps illustrated in FIG. 13 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 13 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process 1300.

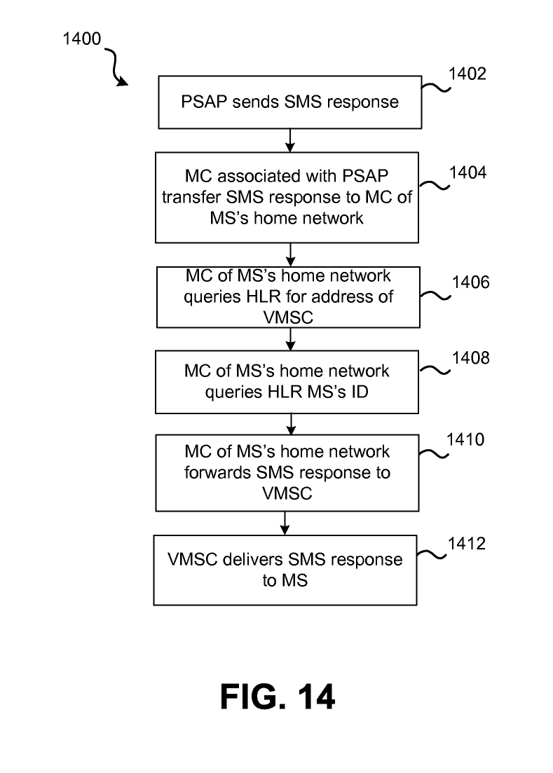

FIG. 14 is a simplified flow diagram illustrating a process 1400 for the routing of a response according to one embodiment. An SMS message is discussed below for illustration purposes; however, other non-real time messages may be used for communicating with the emergency service provider. The process 1400 is performed by processing logic that comprises hardware (circuitry, dedicated logic, etc.), software (such as is run on a general purpose computing system or a dedicated machine), firmware (embedded software), or any combination thereof. In one embodiment, the process 1400 is performed by one or more computer systems 2100 described in FIG. 21.

Process 1400 begins at step 1402 with PSAP 240 (e.g. SME 248 in PSAP 240) constructing an SMS response to mobile station 1110. The response includes mobile station 1110's MDN received in step 1214 of process 1200 as the destination address. The response may also include a general emergency number (e.g. 911) or the ESRK or ESRD or an operator specific number as the source address for PSAP 240. In some embodiments, the response is initially transferred to MC 1146. In other embodiments, PSAP 240 sends the SMS response to MC 1134 (i.e. the MC of mobile station 1110's home network). At step 1404, MC 1146 forwards the SMS response to MC 1134, for example using an IP based protocol like SMPP or EMI-UCP or a MAP SMDPP message that includes the source and destination addresses received in step 1402. PSAP 240 or MC 1146 may identify and route to MC 1134 based on leading digits in the destination MDN address which may be unique to the home network 1130 of mobile station 1110. At step 1406, MC 1134 queries HLR 1132 for the address of VMSC 1124. At step 1408, MC 1134 additionally queries HLR 1132 for mobile station's 1110 identity (MSID), which may be a MIN or an IMSI. Steps 1406 and 1408 may normally be combined using common request and response messages. At step 1410, MC 1134 forwards the SMS response to VMSC 1124. At step 1412, VMSC 1124 delivers the SMS response to mobile station 1110. The mobile station may use the received PSAP source address as the destination address for future SMS messages sent to PSAP 240. Since the source address will be the ESRK, ESRD, an operator specific address or an emergency number, the SMS message will be routed correctly. (In the case of an emergency number, steps 1202 to 1214 in FIG. 12 would be used and for an ESRK, ESRD or operator specific number, the normal SMS delivery procedure for 3GPP2 would be used.)

It should be appreciated that the specific steps illustrated in FIG. 14 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 14 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process 1400.

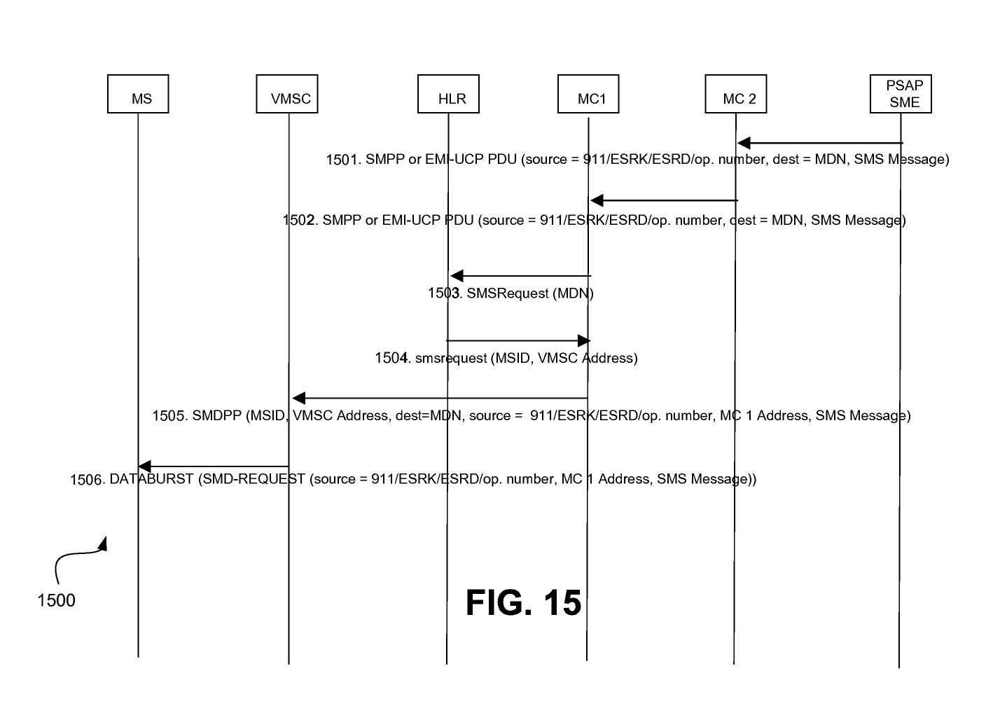

FIG. 15 is a signaling flow diagram illustrating the communications exchanged between various entities in order to route a response according to one embodiment. FIG. 15 is a signaling flow diagram for the flow described with respect to FIG. 14. An SMS message is discussed below for illustration purposes; however, other non-real time messages may be used for communicating with the emergency service provider. The process 1500 is performed by processing logic that comprises hardware (circuitry, dedicated logic, etc.), software (such as is run on a general purpose computing system or a dedicated machine), firmware (embedded software), or any combination thereof. In one embodiment, the process 1500 is performed by one or more computer systems 2100 as described in FIG. 21.

Process 1500 begins at step 1501 with PSAP 240 (e.g. SME 248 in PSAP 240) constructing an SMS response to mobile station 1110. The response includes mobile station 1110's MDN received in step 1214 of process 1200 as the destination address. The response may also include a general emergency number (e.g. 911) or the ESRK or ESRD or an operator specific number as the source address for PSAP 240. In some embodiments, the response is initially transferred from PSAP SME 248 to MC 1146. In other embodiments, PSAP SME 248 sends the SMS response to MC 1134 (i.e. the MC of mobile station 1110's home network). PSAP 240 or MC 1146 may identify and route to MC 1134 based on leading digits in the destination MDN address which may be unique to the home network 1130 of mobile station 1110. At step 1502, MC 1146 forwards the SMS response to MC 1134, for example using an IP based protocol like SMPP or EMI-UCP or a MAP SMDPP message that includes the source and destination addresses received in step 1501. At step 1503 and step 1504, MC 1134 queries HLR 1132 for the address of VMSC 1124 and for mobile station 1110's identity (MSID), which may be a MIN or an IMSI. At step 1505, MC 1134 forwards the SMS response to VMSC 1124 in an SMDPP message and includes the destination MDN address and the source address. At step 1506, VMSC 1124 delivers the SMS response to mobile station 1110. The mobile station may use the received PSAP source address as the destination address for future SMS messages sent to PSAP 240. Since the source address will be the ESRK, ESRD, an operator specific address or an emergency number, the SMS message will be routed correctly. (In the case of an emergency number, steps 1202 to 1214 in FIG. 12 would be used and for an ESRK, ESRD or operator specific number, the normal SMS delivery procedure for 3GPP2 would be used.)

It should be appreciated that the specific steps illustrated in FIG. 15 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 15 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process 1500.

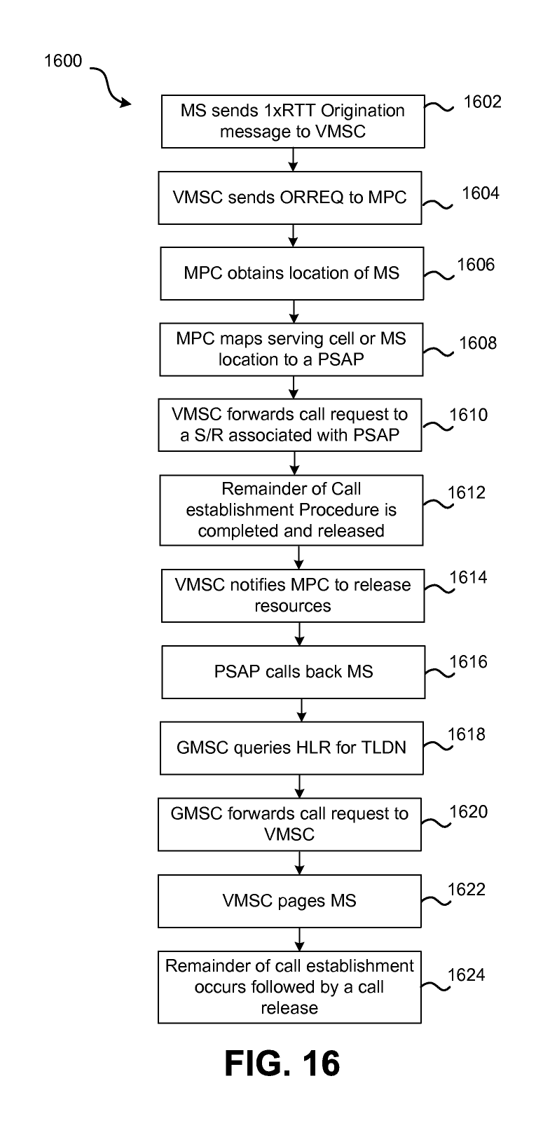

FIG. 16 is a simplified flow diagram illustrating a process 1600 for providing emergency CS Calls and callbacks in parallel to an emergency SMS according to one embodiment. An SMS message is discussed below for illustration purposes; however, other non-real time messages may be used for communicating with the emergency service provider. The process 1600 is performed by processing logic that comprises hardware (circuitry, dedicated logic, etc.), software (such as is run on a general purpose computing system or a dedicated machine), firmware (embedded software), or any combination thereof. In one embodiment, the process 1600 is performed by one or more computer systems 2100 as described in FIG. 21.

Process 1600 begins at step 1602 with mobile station 1110 sending a 1xRTT Origination message to VMSC 1124 containing an emergency destination number (e.g. 911 or 112) to request an emergency CS (e.g., voice) call. This may occur before or after any emergency SMS messages are sent according to FIGS. 12 and 13. At step 1604, if VMSC 1124 does not yet have an ESRK or ESRD for mobile station 1110 (e.g. obtained for a previous emergency SMS message as described in FIGS. 12 and 13), VMSC 1124 sends an Origination Request (ORREQ) to MPC 1126. The request includes mobile station 1110's MSID, MDN, mobile positioning capabilities (MPCAP) and serving cell ID (if known) as well as a VMSC identifier (MSC ID). At step 1606, MPC 1126 may obtain the location of mobile station 1110 by sending a request to PDE 1128, which may then interact with mobile station 1110 using the IS-801 positioning protocol (e.g., as shown in steps 1904 to 1906 of FIG. 19). At step 1608, MPC 1126 maps the serving cell ID or MS location to PSAP 240 (e.g., a PSAP that services that location or cell area). MPC 1126 additionally assigns an ESRK or determines an ESRD that identifies the PSAP (as well as MPC 1126) and returns the ESRK or ESRD to VMSC 1124. In some embodiments, MPC 1126 stores mobile station 1110's MSID, MDN, ESRK or ESRD, serving cell ID, location if obtained and the VMSC address. At step 1610, VMSC 1124 forwards the call request in an SS7 ISUP IAM message to a PSAP selective router (S/R—not shown). For an ESRK, the ISUP called Party Number may be set by the VMSC to an emergency number (e.g. 911) and the ISUP Calling Party Number may be set to the ESRK. The S/R uses the ESRK to determine the PSAP (e.g., ESNE 244 for PSAP 240) and signals the call to the PSAP but sends only the ESRK. The PSAP can obtain the MDN (e.g. to call back the mobile station 1110 in steps 1616 to 1624) by performing process 1900 in FIG. 19 after the call is established in step 1612 and before callback occurs in step 1616. For an ESRD, the ISUP Called Party Number may be set by the VMSC to an emergency number e.g. 911) or the ESRD, the ISUP calling Party Number may be set to the MS's MDN and the ISUP Generic Digits Parameter (GDP) may be set to the ESRD. The S/R uses the ESRD in the GDP to determine the PSAP (e.g. ESNE 244) and forwards the call to the PSAP including the MSISDN and ESRD. At step 1612, the remainder of the call establishment procedure is completed and some time later the call is released. At step 1614, after the EMC is released and after some interval following the last emergency SMS message from mobile station 1110, VMSC 1124 notifies MPC 1126 that any resources such as an ESRK can be released.

At step 1616, PSAP 240 (e.g. ESNE 244 in PSAP 240) may call back mobile station 1110 and, if so, sends a call request (e.g. ISUP IAM message) to GMSC 1136—possibly via an S/R and/or the PSTN; the call request is routed using mobile station 1110's MDN. This step may occur following steps 1602 to 1612 in FIG. 16 or following steps 1202 to 1214 in FIG. 12 (i.e. the PSAP may call back the mobile station after an emergency SMS message is received), for example. At step 1618, GMSC 1136 sends a MAP Location Request (LOCREQ) to query HLR 1132 for a Temporary Local Directory Number (TLDN) using mobile station 1110's MDN. HLR 1132 in turn sends a MAP Routing Request (ROUTREQ) to query VMSC 1124, which returns the TLDN and its own identity. HLR 1132 forwards this response to GMSC 1136 and further includes the identity (e.g. MIN) of mobile station 1110. At step 1620, GMSC 1136 forwards the call request to the VMSC using the TLDN for routing. At step 1622, VMSC 1124 recognizes the call is for mobile station 1110 from the TLDN and pages the mobile station. At step 1624, the remainder of call establishment occurs followed some time later by call release.

It should be appreciated that the specific steps illustrated in FIG. 16 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 16 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process 1600.

FIG. 17 shows the communications exchanged between various entities in order providing emergency CS Calls and callbacks according to the embodiment. FIG. 17 is a signaling flow diagram for the flow described with respect to FIG. 16. An SMS message is discussed below for illustration purposes; however, other non-real time messages may be used for communicating with the emergency service provider. The process 1700 is performed by processing logic that comprises hardware (circuitry, dedicated logic, etc.), software (such as is run on a general purpose computing system or a dedicated machine), firmware (embedded software), or any combination thereof. In one embodiment, the process 1700 is performed by one or more computer systems 2100 as described in FIG. 21.

Process 1700 begins at step 1701 with mobile station 1110 sending a 1XRTT Origination message to VMSC 1124 containing an emergency destination number (e.g. 911 or 112) to request an emergency CS (e.g., voice) call. This may occur before or after any emergency SMS messages are sent. At step 1702, if VMSC 1124 does not yet have an ESRK or ESRD for mobile station 1110 (e.g. obtained for a previous emergency SMS message), VMSC 1124 sends an Origination Request (ORREQ) to MPC 1126. The request includes mobile station 1110's MSID, MDN, mobile positioning capabilities (MPCAP) and serving cell ID (if known) as well as a VMSC identifier (MSC ID). At step 1703, MPC 1126 may obtain the location of mobile station 1110 by sending a request to PDE 1128, which may then interact with mobile station 1110 using the IS-801 positioning protocol (e.g., as shown in steps 1904 to 1906 of FIG. 19). At step 1704, MPC 1126 maps the serving cell ID or MS location to PSAP 240 (e.g., a PSAP that services that location or cell area). MPC 1126 additionally assigns an ESRK or determines an ESRD that identifies the PSAP (as well as MPC 1126) and returns the ESRK or ESRD to VMSC 1124. In some embodiments, MPC 1126 stores mobile station 1110's MSID, MDN, ESRK or ESRD, serving cell ID, location if obtained and the VMSC ID for VMSC 1124. At step 1705, VMSC 1124 forwards the call request in an SS7 ISUP IAM message to a PSAP selective router (S/R—not shown). The S/R may be chosen by VMSC 1124 based on the ESRK or ESRD. For an ESRK, the ISUP called Party Number is set by the VMSC to an emergency number (e.g. 911) and the ISUP Calling Party Number is set to the ESRK. The S/R uses the ESRK to determine the PSAP (e.g., PSAP 240) and signals the call to the PSAP (e.g. to ESNE 244 in PSAP 240) but may send only the ESRK. The PSAP can obtain the MDN (e.g. to call back the mobile station 1110 in steps 1709 to 1716) by performing process 1900 in FIG. 19 after the call is established in step 1706 and before callback occurs in step 1709. For an ESRD, the ISUP Called Party Number is set by the VMSC to an emergency number e.g. 911) or the ESRD, the ISUP calling Party Number is set to the MS's MDN and the ISUP Generic Digits Parameter (GDP) is set to the ESRD. The S/R uses the ESRD in the GDP to determine the PSAP and forwards the call to the PSAP (e.g. to ESNE 244 in PSAP 240) including the MSISDN and ESRD. At step 1706, the remainder of the call establishment procedure is completed and sometime later the call is released. At step 1707 and 1708, after the EMC is released and after some interval following the last emergency SMS message from mobile station 1110 (if emergency SMS messages are being sent), VMSC 1124 notifies MPC 1126 that any resources such as an ESRK can be released.

At step 1709, PSAP 240 (e.g. ESNE 244 in PSAP 240) may call back mobile station 1110 and, if so, sends a call request (e.g. ISUP JAM message) to GMSC 1136—possibly via an S/R and/or the PSTN; the call request is routed to GMSC 1136 using mobile station 1110's MDN. This step may occur following steps 1701 to 1706 in FIG. 17 or following steps 1301 to 1307 in FIG. 13 (i.e. the PSAP may call back the mobile station after an emergency SMS message is received), for example. At step 1710, GMSC 1136 sends a MAP Location Request (LOCREQ) to query HLR 1132 for a Temporary Local Directory Number (TLDN) using mobile station 1110's MDN. HLR 1132 in turn sends a MAP Routing Request (ROUTREQ) to query VMSC 1124 in step 1711. VMSC 1124 returns the TLDN and its own identity (MSC ID) in step 1712. HLR 1132 then returns this information to GMSC 1136 in step 1713 and further includes the identification (MIN) of mobile station 1110. At step 1714, GMSC 1136 forwards the call request to the VMSC using the TLDN for routing. At step 1715, VMSC 1124 recognizes the call is for mobile station 1110 from the TLDN and pages the mobile station. At step 1716, the remainder of call establishment occurs followed some time later by call release.

In some embodiments of process 1700, when step 1701 occurs after one or more emergency SMS messages have been sent by mobile station 1110 to PSAP 240 according to process 1200 of FIG. 12 or process 1300 of FIG. 13 and/or before VMSC 1124 requests MPC 1126 to release any ESRK or ESRD (e.g. as in steps 1308 and 1309 of FIG. 13), VMSC 1124 and PSAP S/R 242 may use the same ESRK or ESRD for routing the emergency call in step 1705 as were used to route the earlier emergency SMS messages (e.g. in steps 1305, 1306 and 1307 of FIG. 13). If steps 1701 to 1706 occur before mobile station 1110 sends an emergency SMS message to PSAP 240 according to process 1200 of FIG. 12 and process 1300 of FIG. 13, VMSC 1124 may include the same ESRK or ESRD as the destination address for the emergency SMS message in step 1210 of process 1200 and step 1305 of FIG. 13 as was used to route the CS emergency call in step 1705 of FIG. 17. Thus, regardless of whether a CS emergency call occurs before an emergency SMS transfer or afterwards, both the emergency call and the emergency SMS messages can be sent to the same PSAP 240. In addition, if PSAP 240 records the ESRK or the ESRD and the mobile station 210 MSISDN together with the identity of the PSAP operator, PSAP 240 (by retrieving the operator identity) can send the CS emergency call and the emergency SMS message(s) to the same PSAP operator. This may be a significant advantage in ensuring that all emergency communication from the same user is seen by the same operator.

It should be appreciated that the specific steps illustrated in FIG. 17 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 17 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process 1700.

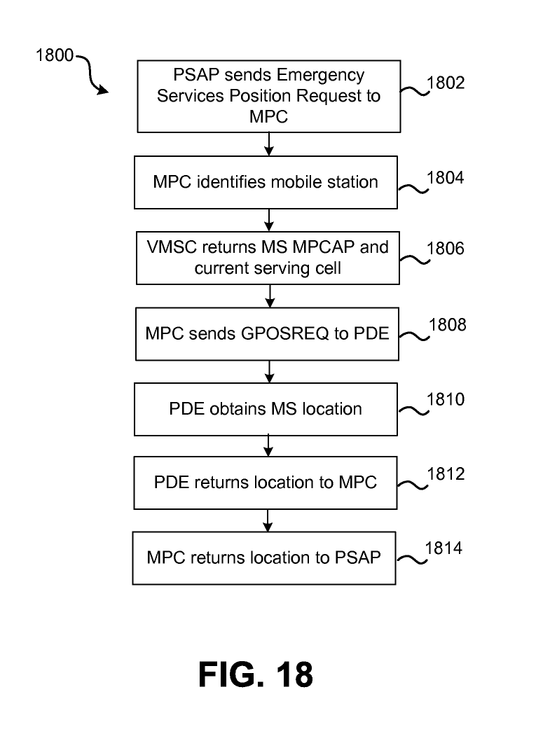

FIG. 18 is a simplified flow diagram illustrating a process 1800 for performing a location procedure used to support emergency SMS messaging according to one embodiment. An SMS message is discussed below for illustration purposes; however, other non-real time messages may be used for communicating with the emergency service provider. The process 1800 is performed by processing logic that comprises hardware (circuitry, dedicated logic, etc.), software (such as is run on a general purpose computing system or a dedicated machine), firmware (embedded software), or any combination thereof. In one embodiment, the process 1800 is performed by one or more computer systems 2100 as described in FIG. 21.

It may be beneficial for PSAP 240 to have or obtain an accurate initial location estimate for mobile station 1110 or an updated location estimate—e.g. after receiving an emergency SMS message and before receiving any CS EMC. PSAP 240 may also or instead have or obtain the MDN for mobile station 1110 when a CS EMC was delivered using an ESRK in order to call back mobile station 1110 at a later time. As shown in FIG. 18, process 1800 begins at step 1802 with PSAP 240 (e.g. to ESME 250 in PSAP 240) sending an Emergency Services Position Request to MPC 1126 [the MPC identified by the ESRK or ESRD received in an earlier SMS message (e.g. in step 1214 of FIG. 12) or with an earlier CS EMC (e.g. in step 1610 of FIG. 16)]. In some embodiments, PSAP 240 includes, in the request, the ESRK or MDN plus ESRD. At step 1804, MPC 1126 identifies mobile station 1110 from the ESRK or MDN plus the ESRD received in step 1802. In some embodiments, the identification can be based on the information previously stored either in step 1208 of FIG. 12 or step 1608 of FIG. 16. In certain embodiments, MPC 1126 sends an Inter System Position Request (ISPOSREQ) to VMSC 1124 (e.g. as identified from information stored in step 1208 of FIG. 12 or step 1608 of FIG. 16, for example) and includes the IMSI, MIN and/or MDN stored and received earlier from VMSC 1124. In this embodiment and at step 1806, VMSC 1124 returns the mobile station positioning capabilities (MPCAP) and current serving cell. At step 1808, MPC 1126 sends a Geo Position Request (GPOSREQ) to PDE 1128 and includes the VMSC ID for VMSC 1124 and the MPCAP, serving cell ID and MIN or IMSI for mobile station 1110. At step 1810, PDE 1128 obtains the mobile station location—e.g. using the Telecommunications Industry Association (TIA) IS-801 or 3GPP2 C.S0022 positioning protocol as described in American National Standards Institute (ANSI) standard J-STD-036 which may invoke positioning using A-GPS, A-GNSS, AFLT, E-CID, for example, or using other techniques. At step 1812, PDE 1128 returns the location obtained in step 1810 to MPC 1126. At step 1814, MPC 1126 returns the location to PSAP 240 and may also return the MDN of mobile station 1110 if the request in step 1802 contains an ESRK.

It should be appreciated that the specific steps illustrated in FIG. 18 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 18 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process 1800.

FIG. 19 is a diagram illustrating the communications exchanged between various entities in order to perform a location procedure used to support emergency SMS messaging according to one embodiment. FIG. 19 is a signaling flow diagram for the flow described with respect to FIG. 18. An SMS message is discussed below for illustration purposes; however, other non-real time messages may be used for communicating with the emergency service provider. The process 1900 is performed by processing logic that comprises hardware (circuitry, dedicated logic, etc.), software (such as is run on a general purpose computing system or a dedicated machine), firmware (embedded software), or any combination thereof. In one embodiment, the process 1900 is performed by one or more computer systems 2100 as described in FIG. 21.

It may be beneficial for PSAP 240 to have or obtain an accurate initial location estimate for mobile station 1110 or an updated location estimate—e.g. after receiving an emergency SMS message and before receiving any CS EMC. PSAP 240 may also or instead have or obtain the MDN for mobile station 1110 when a CS EMC was delivered using an ESRK in order to call back mobile station 1110 at a later time. As shown in FIG. 19, process 1900 begins at step 1901 with PSAP 240 (e.g. ESME 250 in PSAP 240) sending an Emergency Services Position Request to MPC 1126 [the MPC identified by the ESRK or ESRD received in an earlier SMS message (e.g. in step 1307 of FIG. 13) or with an earlier CS EMC (e.g. in step 1705 of FIG. 17)]. In some embodiments, PSAP 240 includes, in the request, the ESRK or MDN plus ESRD. At step 1902, MPC 1126 identifies mobile station 1110 from the ESRK or MDN plus the ESRD received in step 1901. In some embodiments, the identification can be based on the information previously stored in step 1304 of FIG. 13 or step 1704 of FIG. 17. In certain embodiments, MPC 1126 sends an Inter System Position Request (ISPOSREQ) to VMSC 1124 (e.g. as identified from information stored in step 1304 of FIG. 13 or step 1704 of FIG. 17, for example) and includes the IMSI, MIN and/or MDN stored and received earlier from VMSC 1124. For this embodiment and at step 1903, VMSC 1124 returns the mobile station positioning capabilities (MPCAP) and current serving cell. At step 1904, MPC 1126 sends a Geo Position Request (GPOSREQ) to PDE 1128 and includes the VMSC ID, MPCAP, serving cell ID and MIN or IMSI. At step 1905, PDE 1128 obtains the mobile station location—e.g. using the TIA IS-801 or 3GPP2 C.S0022 positioning protocol as described in ANSI standard J-STD-036 which may invoke positioning using A-GPS, A-GNSS, AFLT, E-CID, for example, or using other techniques. At step 1906, PDE 1128 returns the location obtained in step 1905 to MPC 1126. At step 1907, MPC 1126 returns the location to PSAP 240 and may also return the MDN of mobile station 1110 if the request in step 1901 contains an ESRK.

It should be appreciated that the specific steps illustrated in FIG. 19 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 19 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process 1900.

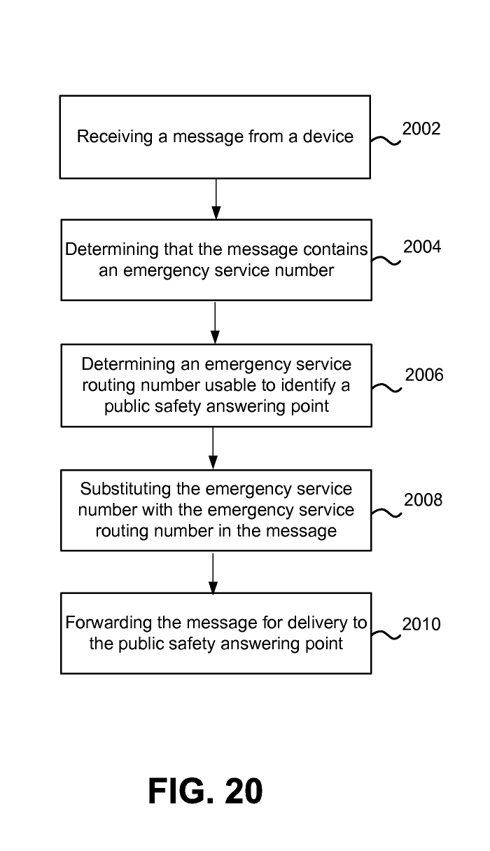

FIG. 20 is a simplified flow diagram illustrating the method for communicating messages with an emergency services provider. An SMS message is discussed below for illustration purposes; however, other non-real time messages may be used for communicating with the emergency service provider. The process 2000 is performed by processing logic that comprises hardware (circuitry, dedicated logic, etc.), software (such as is run on a general purpose computing system or a dedicated machine), firmware (embedded software), or any combination thereof. In one embodiment, the process 2000 is performed by one or more computer systems 2100 as described in FIG. 21.

The process begins at step 2002, wherein the computer system 2100 receives a message from a mobile station 210 or 1110 trying to reach an emergency services provider. In one embodiment, the computer system 2100 represents a Mobile Service Switching Center (MSC), such as a VMSC 224 from FIG. 2 and or VMSC 1124 from FIG. 11. The message may be any non-real time message, such as a text message (e.g., SMS message), image, video, audio clip or any other suitable multimedia message for transmission using embodiments of the invention. At step 2004, the processor 2110 from the computer system 2100 filters or scans the message and determines whether the message contains an emergency service number. The various messages and signaling, discussed herein, may be communicated between the different entities, such as the mobile station 210 or 1110, MSC, and the gateway servers using one or more types of networks, such as a GSM, CDMA, WCDMA, CMDA2000 1x, LTE or any other suitable network.

At step 2006, method performed by components of the computer system 2100 access an emergency service routing number usable to identify a public safety answering point (e.g., PSAP 240). The emergency service routing number may be an emergency service routing key (ESRK) or emergency service routing digits (ESRD). In some embodiments, the emergency service routing number includes determining location information for the mobile station. The location information may be a serving cell identifier or a geographic location.

In one embodiment, determining the emergency service routing number may include sending a query to a gateway server and receiving, from the gateway server, the emergency service routing number, using the transceiver 2150. The gateway server may be a GMLC 226 or an MPC 1126. The emergency services routing number may identify the gateway server and in some embodiments may temporarily identify the mobile station.

At step 2008, the method performed by components of the computer system 2100, such as the processor 2110, may replace the emergency service number with the emergency service routing number in the message. At step 2010, the method performed by components of the computer system 2100, such as the transceiver 2150, may forward the message for delivery to the public safety answering point, wherein delivery of the message is based on the emergency service routing number.

In some embodiments, the computer system 2100 may receiver a second message within a predefined time period and may forward the second message for delivery to the public safety answering point, wherein delivery of the second message is based on the emergency service routing number. The second message may be associated with the same mobile station 210 or 1110.

In other embodiments, the computer system 2100 may also receive a location query for the mobile station 210 or 1110 from the public safety answering point (e.g., PSAP 240), wherein the query is transmitted to the gateway server using the transceiver 2150 and wherein the gateway server determines the mobile station 210 location and returns the location to the public safety answering point. In some embodiments, the public safety answering point may issue a response. In one embodiment the response is a circuit switched emergency voice call. In another embodiment, the response is a non-real time message, such as a text message (e.g., SMS message), or another suitable multimedia message.

It should be appreciated that the specific steps illustrated in FIG. 20 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 20 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process 2000.

A computer system as illustrated in FIG. 21 may be incorporated as part of the previously described entities shown in FIGS. 2 and 11. For example, computer system 2100 can represent some of the components of the mobile devices and/or the computer systems discussed in this application. In some embodiments, elements of FIG. 21 are used to implement a VMSC, SMSC, MS/UE, GMLC, RAN, SAS/SMLC, S/R, ESNE, SME, ESME, PDE, MPC, and/or MC described above. FIG. 21 provides a schematic illustration of one embodiment of a computer system 2100 that can perform the methods provided by various other embodiments, as described herein, and/or can function as mobile station 210 or 1110. It should be noted that FIG. 21 is meant only to provide a generalized illustration of various components, any or all of which may be utilized as appropriate. FIG. 21, therefore, broadly illustrates how individual system elements may be implemented in a relatively separated or relatively more integrated manner.

The computer system 2100 is shown comprising hardware elements that can be electrically coupled via a bus 2105 (or may otherwise be in communication, as appropriate). The hardware elements may include one or more processors 2110, including without limitation one or more general-purpose processors and/or one or more special-purpose processors (such as digital signal processing chips, graphics acceleration processors, and/or the like); one or more input devices 2115, which can include without limitation a mouse, a keyboard and/or the like; and one or more output devices 2120, which can include without limitation a display device, a printer and/or the like.

The computer system 2100 may further include (and/or be in communication with) one or more storage devices 2125, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 2100 may also include a communications subsystem 2130, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 2130 may permit data to be exchanged with a network (such as the network described below, to name one example), other computer systems, and/or any other devices described herein. In many embodiments, the computer system 2100 will further comprise a working memory 2135, which can include a RAM or ROM device, as described above.

The computer system 2100 may also include a transceiver 2150 for transmitting and receiving messages. The transceiver 2150 may comprise components, such as a transmitter and a receiver which are combined and share common circuitry or a single housing or may be separate. The transceiver 2150 may be modified to communicate with one or more network configurations, such as GSM, a CDMA, a WCDMA, a CMDA2000 1xRTT, or a LTE network.

The computer system 2100 also can comprise software elements, shown as being currently located within the working memory 2135, including an operating system 2140, device drivers, executable libraries, and/or other code, such as one or more application programs 2145, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 2125 described above. In some cases, the storage medium might be incorporated within a computer system, such as the system 2100. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 2100 and/or might take the form of source and/or installable code, which, upon compilation and/or installation on the computer system 2100 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 2100) to perform methods in accordance with various embodiments of the invention. According to a set of embodiments, some or all of the procedures of such methods are performed by the computer system 2100 in response to processor 2110 executing one or more sequences of one or more instructions (which might be incorporated into the operating system 2140 and/or other code, such as an application program 2145) contained in the working memory 2135. Such instructions may be read into the working memory 2135 from another computer-readable medium, such as one or more of the storage device(s) 2125. Merely by way of example, execution of the sequences of instructions contained in the working memory 2135 might cause the processor(s) 2110 to perform one or more procedures of the methods described herein.

The terms “machine-readable medium” and “computer-readable medium,” as used herein, refer to any medium that participates in providing data that causes a machine to operate in a specific fashion. Computer readable storage medium does not refer to transitory propagating signals. In an embodiment implemented using the computer system 2100, various computer-readable media might be involved in providing instructions/code to processor(s) 2110 for execution and/or might be used to store such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 2125. Volatile media include, without limitation, dynamic memory, such as the working memory 2135.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, etc.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the embodiments described herein. Also, a number of steps may be undertaken before, during, or after the above elements are considered. Accordingly, the above description does not bound the scope of the claims.

What is claimed is:

1. A method comprising:
receiving a message from a mobile station;
determining that the message contains an emergency service number;
determining an emergency service routing number usable to identify a public safety answering point;
substituting the emergency service number with the emergency service routing number in the message; and
forwarding the message for delivery to the public safety answering point, wherein the delivery of the message is based on the emergency service routing number.

2. The method of claim 1, wherein the emergency service routing number is an emergency service routing key (ESRK) or emergency service routing digits (ESRD).

3. The method of claim 1, wherein determining the emergency service routing number includes determining location information for the mobile station.

4. The method of claim 3, wherein the location information is a serving cell identifier or a geographic location.

5. The method of claim 1, wherein determining the emergency service routing number includes sending a query to a gateway server and receiving, from the gateway server, the emergency service routing number.

6. The method of claim 5, wherein the gateway server is a Gateway Mobile Location Center (GMLC) or a Mobile Position Center (MPC).

7. The method of claim 5, wherein the emergency service routing number identifies the gateway server.

8. The method of claim 5, further comprising receiving a location query for the mobile station from the public safety answering point, wherein the location query is transmitted to the gateway server and wherein the gateway server obtains a location associated with the mobile station and returns the location to the public safety answering point.

9. The method of claim 1, further comprising:
receiving another message from the mobile station within a predefined time period; and
forwarding the another message for delivery to the public safety answering point, wherein the delivery of the another message is based on the emergency service routing number.

10. The method of claim 1, further comprising:
receiving a request to establish an emergency voice call from the mobile station; and
forwarding the request to the public safety answering point, wherein routing of the request is based on the emergency service routing number.

11. The method of claim 1, wherein the message to the public safety answering point is forwarded through a Short Message Service Center (SMSC).

12. The method of claim 1, wherein the message to the public safety answering point is forwarded through a Message Center (MC).

13. The method of claim 10, wherein the request to establish the emergency voice call is received after receiving the message from the mobile station.

14. The method of claim 10, wherein the request to establish the emergency voice call is received before receiving the message from the mobile station.

15. The method of claim 1, further comprising receiving a response from the public safety answering point.

16. The method of claim 15, wherein the response is a circuit switched voice call.

17. The method of claim 15, wherein the response is an SMS response message.

18. The method of claim 1, wherein the message comprises a text message.

19. The method of claim 18, wherein the text message comprises an SMS message.

20. The method of claim 1, wherein the message comprises a non-real time message.

21. The method of claim 1, wherein the message is received using a GSM, a CDMA, a WCDMA, a CMDA2000 1x, or a LTE network.

22. A device, comprising:
a transceiver configured to receive a message from a mobile station; and
a processor configured to:
determine that the message contains an emergency service number;
determine an emergency service routing number usable to identify a public safety answering point; and
substitute the emergency service number with the emergency service routing number in the message;
the transceiver further configured to forward the message for delivery to the public safety answering point, wherein the delivery of the message is based on the emergency service routing number.

23. The device of claim 22, wherein the emergency service routing number is an emergency service routing key (ESRK) or emergency service routing digits (ESRD).

24. The device of claim 22, wherein determining the emergency service routing number by the processor includes determining location information for the mobile station.

25. The device of claim 24, wherein the location information is a serving cell identifier or a geographic location.

26. The device of claim 22, wherein determining the emergency service routing number by the processor includes sending, via the transceiver, a query to a gateway server and receiving, from the gateway server via the transceiver, the emergency service routing number.

27. The device of claim 26, wherein the gateway server is a Gateway Mobile Location Center (GMLC) or a Mobile Position Center (MPC).

28. The device of claim 26, wherein the emergency service routing number identifies the gateway server.

29. The device of claim 26, wherein the transceiver is further configured to receive a location query for the mobile station from the gateway server, access a location and return the location to the gateway server and wherein the gateway server returns the location to the public safety answering point.

30. The device of claim 22, wherein the transceiver is further configured to:
receive another message from the mobile station within a predefined time period; and
forward the another message for delivery to the public safety answering point, wherein the delivery of the another message is based on the emergency service routing number.

31. The device of claim 22, wherein the transceiver is further configured to:
receive a request to establish an emergency voice call from the mobile station; and
forward the request to the public safety answering point, wherein routing of the request is based on the emergency service routing number.

32. The device of claim 22, wherein the message to the public safety answering point is forwarded through a Short Message Service Center (SMSC).

33. The method of claim 22, wherein the message to the public safety answering point is forwarded through a Message Center (MC).

34. The device of claim 31, wherein the request to establish the emergency voice call is received after receiving the message from the mobile station.

35. The device of claim 31, wherein the request to establish the emergency voice call is received before receiving the message from the mobile station.

36. The device of claim 22, wherein the transceiver is further configured to receive a response from the public safety answering point for delivery to the mobile station.

37. The device of claim 36, wherein the response is a circuit switched voice call.

38. The device of claim 36, wherein the response is an SMS response message.

39. The device of claim 22, wherein the message comprises a text message.

40. The device of claim 39, wherein the text message comprises an SMS message.

41. The device of claim 22, wherein the message comprises a non-real time message.

42. The device of claim 22, wherein the transceiver is configured to receive and transmit the message using a GSM, a CDMA, a WCDMA, a CMDA2000 1xRTT, or a LTE network.

43. The device of claim 22, wherein the device is a Visited Mobile services Switching Center (VMSC), a Short Message Service Center (SMSC) or a Message Center (MC).

44. A non-transitory computer readable storage medium coupled to a processor, wherein the non-transitory computer readable storage medium comprises instructions executable by the processor, comprising:
receiving a message from a mobile station;
determining that the message contains an emergency service number;
determining an emergency service routing number usable to identify a public safety answering point;
substituting the emergency service number with the emergency service routing number in the message; and
forwarding the message for delivery to the public safety answering point, wherein the delivery of the message is based on the emergency service routing number.

45. A device, comprising:
means for receiving a message from a mobile station;
means for determining that the message contains an emergency service number;
means for determining an emergency service routing number usable to identify a public safety answering point;
means for substituting the emergency service number with the emergency service routing number in the message; and
means for forwarding the message for delivery to the public safety answering point, wherein the delivery of the message is based on the emergency service routing number.
